(19) United States
(12) Patent Application Publication
(10) Pub. No.: US 2013/0250614 A1
(43) Pub. Date: Sep. 26, 2013

(54) ILLUMINATION ASSEMBLY AND METHOD OF FORMING SAME

(71) Applicants: David Scott Thompson, West Lakeland, MN (US); John A. Wheatley, Lake Elmo, MN (US); Gilles J. Benoit, Minneapolis, MN (US)

(72) Inventors: David Scott Thompson, West Lakeland, MN (US); John A. Wheatley, Lake Elmo, MN (US); Gilles J. Benoit, Minneapolis, MN (US)

(73) Assignee: 3M INNOVATIVE PROPERTIES COMPANY, St. Paul, MN (US)

(21) Appl. No.: 13/991,490

(22) PCT Filed: Dec. 2, 2011
(86) PCT No.: PCT/US2011/062981

§ 371 Date: Jun. 4, 2013

Related U.S. Application Data
(60) Provisional application No. 61/419,832, filed on Dec. 4, 2010.

(51) Int. Cl. F21V 8/00

(52) U.S. Cl. CPC G02B 6/0015; G02B 6/0065
USPC 362/608; 29/428

(57) ABSTRACT

An illumination assembly that includes a light guide and a plurality of light sources positioned to direct light into the light guide through an input surface of the light guide is disclosed. The assembly further includes a structured surface layer positioned between the plurality of light sources and the input surface of the light guide. The structured surface layer includes a substrate and a plurality of structures on a first surface of the substrate facing the plurality of light sources. The plurality of structures includes a refractive index n1 that is different from a refractive index n₂ of the light guide.

### RELATED APPLICATION

Co-owned and copending U.S. Provisional Patent Application No. 61/419,833, entitled ILLUMINATION ASSEMBLY AND METHOD OF FORMING SAME is incorporated herein by reference.

### FIELD

The present disclosure relates to illumination assemblies suitable for illuminating a display or other graphic from behind, commonly referred to as backlights. The disclosure is particularly suited, but not necessarily limited, to edge-lit illumination assemblies that include a solid light guide.

### BACKGROUND

Historically, simple illumination assemblies such as backlight devices included only three main components: light sources or lamps, a back reflector, and a front diffuser. Such systems are still in use for general purpose advertising signs and for indoor lighting applications.

Over recent years, refinements have been made to this basic design by adding other components to increase brightness or reduce power consumption, increase uniformity, and/or reduce thickness. The refinements have been fueled by demands in the high-growth consumer electronics industry for products that incorporate liquid crystal displays (LCDs), such as computer monitors, television monitors, mobile phones, digital cameras, pocket-sized MP3 music players, personal digital assistants (PDAs), and other hand-held devices. Some of these refinements, such as the use of solid light guides to allow the design of very thin backlights, and the use of light management films such as linear prismatic films and reflective polarizing films to increase on-axis brightness, are mentioned herein in connection with further background information on LCD devices.

Although some of the above-listed products can use ordinary ambient light to view the display, most include a backlight to make the display visible. In the case of LCD devices, this is because an LCD panel is not self-illuminating, and thus is usually viewed using an illumination assembly or backlight. The backlight is situated on the opposite side of the LCD panel from the viewer, such that light generated by the backlight passes through the LCD to reach the viewer. The backlight incorporates one or more light sources, such as cold cathode fluorescent lamps (CCFLs) or light emitting diodes (LEDs), and distributes light from the sources over an output area or surface that matches the viewable area of the LCD panel. Light emitted by the backlight desirably has sufficient brightness and sufficient spatial uniformity over the output area of the backlight to provide the user with a satisfactory viewing experience of the image produced by the LCD panel.

LCD devices generally fall within one of three categories, and backlights are used in two of these categories. In a first category, known as “transmission-type,” the LCD panel can be viewed only with the aid of an illuminated backlight. That is, the LCD panel is configured to be viewed only “in transmission,” with light from the backlight being transmitted through the LCD on its way to the viewer. In a second category, known as “reflective-type,” the backlight is eliminated and replaced with a reflective material, and the LCD panel is configured to be viewed only with light sources situated on the viewer-side of the LCD. Light from an external source (e.g., ambient room light) passes from the front to the back of the LCD panel, reflects off of the reflective material, and passes again through the LCD on its way to the viewer. In a third category, known as “transflective-type,” both a backlight and a partially reflective material are placed behind the LCD panel, which is configured to be viewed either in transmission if the backlight is turned on, or in reflection if the backlight is turned off and sufficient ambient light is present.

The illumination assemblies described in the detailed description below can generally be used both in transmission-type LCD displays and in transflective-type LCD displays.

Besides the three categories of LCD displays discussed above, backlights can also fall into one of two categories depending on where the internal light sources are positioned relative to the output area or surface of the backlight, where the backlight “output area” corresponds to the viewable area or region of the display device. The “output area” of a backlight is sometimes referred to herein as an “output region” or “output surface” to distinguish between the region or surface itself and the area (the numerical quantity having units of square meters, square millimeters, square inches, or the like) of that region or surface.

In “edge-lit” backlights, one or more light sources are disposed—from a plan-view perspective—along an outer border or periphery of the backlight construction, generally outside the area or zone corresponding to the output area. Often, the light source(s) are shielded from view by a frame or bezel that borders the output area of the backlight. The light source(s) typically emit light into a component referred to as a “light guide,” particularly in cases where a very thin profile backlight is desired, as in laptop computer displays. The light guide is a clear, solid, and relatively thin plate whose length and width dimensions are on the order of the backlight output area. The light guide uses total internal reflection (TIR) to transport or guide light from the edge-mounted light sources across the entire length or width of the light guide to the opposite edge of the backlight, and a non-uniform pattern of localized extraction features can be provided on a surface of the light guide to redirect some of this guided light out of the light guide toward the output area of the backlight. Other methods of gradual extraction include using a tapered solid guide, where the sloping top surface causes a gradual extraction of light as the TIR angle is, on average, now reached by greater numbers of light rays as the light propagates away from the light source. Such backlights typically also include light management films, such as a reflective material disposed behind or below the light guide, and a reflective polarizing film and prismatic Brightness Enhancement Films (BEF) film(s) disposed in front of or above the light guide, to increase on-axis brightness.

In “direct-lit” backlights, one or more light sources are disposed—from a plan-view perspective—substantially within the area or zone corresponding to the output area, normally in a regular array or pattern within the zone. Alternatively, one can say that the light source(s) in a direct-lit backlight are disposed directly behind the output area of the backlight. Because the light sources are potentially directly viewable through the output area, a strongly diffusing plate is typically mounted above the light sources to spread light over the output area to veil the light sources from direct view. Again, light management films, such as a reflective polarizer film, and prismatic BEF film(s), can also be placed atop the diffuser plate for improved on-axis brightness and efficiency.

In some cases, a direct-lit backlight may also include one or some light sources at the periphery of the backlight, or an edge-lit backlight may include one or some light sources directly behind the output area. In such cases, the backlight is considered “direct-lit” if most of the light originates from directly behind the output area of the backlight, and “edge-lit” if most of the light originates from the periphery of the output area of the backlight.

### SUMMARY

In one aspect, the present disclosure provides an illumination assembly that includes a light guide including an output surface and an input surface along at least one edge of the light guide that is substantially orthogonal to the output surface; and a plurality of light sources positioned to direct light into the light guide through the input surface. The assembly further includes a structured surface layer positioned between the plurality of light sources and the input surface of the light guide, where the structured surface layer includes a substrate and a plurality of structures on a first surface of the substrate facing the plurality of light sources. The plurality of structures includes a refractive index n₁ that is different from a refractive index n₂ of the light guide.

In another aspect, the present disclosure provides a display system that includes a display panel; and an illumination assembly disposed to provide light to the display panel. The assembly includes a light guide including an output surface and an input surface along an edge of the light guide that is substantially orthogonal to the output surface; and a plurality of light sources positioned to direct light into the light guide through the input surface. The assembly also includes a structured surface layer positioned between the plurality of light sources and the input surface of the light guide, where the structured surface layer includes a substrate and a plurality of structures on a first surface of the substrate facing the plurality of light sources. The plurality of structures includes a refractive index n₁ that is greater than a refractive index n₂ of the light guide.

In another aspect, the present disclosure provides a method of forming an illumination assembly that includes forming a light guide including an output surface and an input surface along at least one edge of the light guide that is substantially orthogonal to the output surface; positioning a plurality of light sources proximate the input surface such that the light sources are operable to direct light into the light guide through the input surface; and attaching a structured surface layer to the input surface of the light guide such that the structured surface layer is between the plurality of light sources and the input surface. The structured surface layer includes a substrate and a plurality of structures on a first surface of the substrate facing the plurality of light sources, where the plurality of structures includes a refractive index n₁ that is greater than a refractive index n₂ of the light guide.

### BRIEF DESCRIPTION OF THE DRAWINGS

Throughout the specification, reference is made to the appended, drawings, where like reference numerals designate like elements, wherein:

FIG. 1A is a schematic cross-section view of one embodiment of an illumination assembly that includes a structured surface layer.

FIG. 1B is a schematic plan view of the illumination assembly of FIG. 1A.

FIGS. 2A-D are schematic cross-section views of various embodiments of structured surface layers.

FIG. 3 is a schematic cross-section view of one embodiment of a structured surface layer article.

FIG. 4 is a schematic cross-section view of one embodiment of a display system.

FIG. 5 is a schematic cross-section view of another embodiment of an illumination assembly that does not include a structured surface layer.

FIG. 6 is a graph of luminance versus position within a light guide for the illumination assembly of FIG. 5.

FIG. 7 is a graph of luminance versus position within a light guide for one embodiment of an illumination assembly.

FIG. 8 is a graph of luminance versus position within a light guide for another embodiment of an illumination assembly.

FIG. 9 is a graph of luminance versus position within a light guide for another embodiment of an illumination assembly.

FIGS. 10A-B are graphs of uniformity versus LED pitch for various embodiments of illumination assemblies.

FIG. 11 is a micrograph of one embodiment of a diamond used in a diamond turning machine.

FIGS. 12A-B are micrographs of various embodiments of structured surface layers.

FIGS. 13A-C are graphs of luminance versus position in the light guide an prometric images of one embodiment of an illumination assembly that does not include a structured surface layer.

FIGS. 14A-C are graphs of luminance versus position in the light guide an prometric images of one embodiment of an illumination assembly.

FIGS. 15A-C are graphs of luminance versus position in the light guide an prometric images of one embodiment of an illumination assembly.

FIG. 16A is a graph of coupling efficiency versus LED to light guide distance for various embodiments illumination assemblies.

FIG. 16B is a graph of uniformity versus LED to light guide distance of the illumination assemblies of FIG. 16A.

FIG. 17A is a graph of coupling efficiency versus LED to light guide distance for various embodiments illumination assemblies.

FIG. 17B is a graph of uniformity versus LED to light guide distance of the illumination assemblies of FIG. 16A.

FIG. 18 is a graph of Radiance versus angle for various embodiments of illumination assemblies.

FIG. 19 is a graph of the fraction of light outside the TIR cone versus the refractive index of a light guide for various embodiments of illumination assemblies.

FIG. 20A is a graph of height versus position for one embodiment of a structure of a structured surface layer.

FIG. 20B is a graph of surface normal distribution for the structure of FIG. 20A.

FIG. 20C is a graph of surface normal probability distribution for the structure of FIG. 20A.

FIGS. 21A-C are graphs of luminance versus position in a light guide for an illumination assembly that includes a structured surface layer having the structures illustrated in FIGS. 20A-C.

FIG. 22A is a graph of height versus position for another embodiment of a structure of a structured surface layer.

FIG. 22B is a graph of surface normal distribution for the structure of FIG. 22A.

FIG. 22C is a graph of surface normal probability distribution for the structure of FIG. 22A.

FIGS. 23A-C are graphs of luminance versus position in a light guide for an illumination assembly that includes a structured surface layer having the structures illustrated in FIGS. 22A-C.

FIG. 24A is a graph of height versus position for another embodiment of a structure of a structured surface layer.

FIG. 24B is a graph of surface normal distribution for the structure of FIG. 24A.

FIG. 24C is a graph of surface normal probability distribution for the structure of FIG. 24A.

FIGS. 25A-C are graphs of luminance versus position in a light guide for an illumination assembly that includes a structured surface layer having the structures illustrated in FIGS. 24A-C.

FIG. 26A is a graph of height versus position for another embodiment of a structure of a structured surface layer.

FIG. 26B is a graph of surface normal distribution for the structure of FIG. 26A.

FIG. 26C is a graph of surface normal probability distribution for the structure of FIG. 26A.

FIGS. 27A-C are graphs of luminance versus position in a light guide for an illumination assembly that includes a structured surface layer having the structures illustrated in FIGS. 26A-C.

### DETAILED DESCRIPTION

In general, the present disclosure describes illumination assemblies that provide brightness uniformity and spatial uniformity that are adequate for the intended application. Such assemblies can be used for any suitable lighting application, e.g., displays, signs, general lighting, etc. In some embodiments, the described illumination assemblies include a light guide, a plurality of light sources operable to direct light into the light guide, and a structured surface layer positioned between the light sources and the light guide. The described assemblies can be configured to provide a uniform output light flux distribution at output surfaces of the assemblies. The term “uniform” refers to light distributions that have no observable brightness features or discontinuities that would be objectionable to a viewer. The acceptable uniformity of an output light flux distribution will often depend on the application, e.g., a uniform output light flux distribution in a general lighting application may not be considered uniform in a display application.

As used herein, the term “output light flux distribution” refers to the variation in brightness over the output surface of the assembly or light guide. The term “brightness” refers to the light output per unit area into a unit solid angle (cd/m²).

Illumination assemblies that include light sources such as LEDs and solid light guides for distributing the light of the light sources often face a number of brightness uniformity challenges. One of these challenges is the uniform distribution of the light over large areas. This is typically addressed by optimizing the shape and pattern or density gradient of extraction features that are formed in a surface of the light guide or within the light guide. Another challenge is the brightness uniformity near the injection edge of the light guide. There are two factors that can cause brightness non-uniformity at the input surface of the light guide: (1) as the light gets injected into the solid light guide from air, it is refracted within a total internal reflection (TIR) cone, for example, of about +/−42 degrees for a light guide with a refractive index of 1.49; and (2) LEDs are point sources that cannot easily be transformed into line sources. As a result, discreet point sources inject cones of light of about a 42 degree half angle into the guide, and brightness uniformity near the injection edge of the guide can only be achieved at a certain distance away from this edge into the light guide where there is a significant overlap between neighboring cones of light.

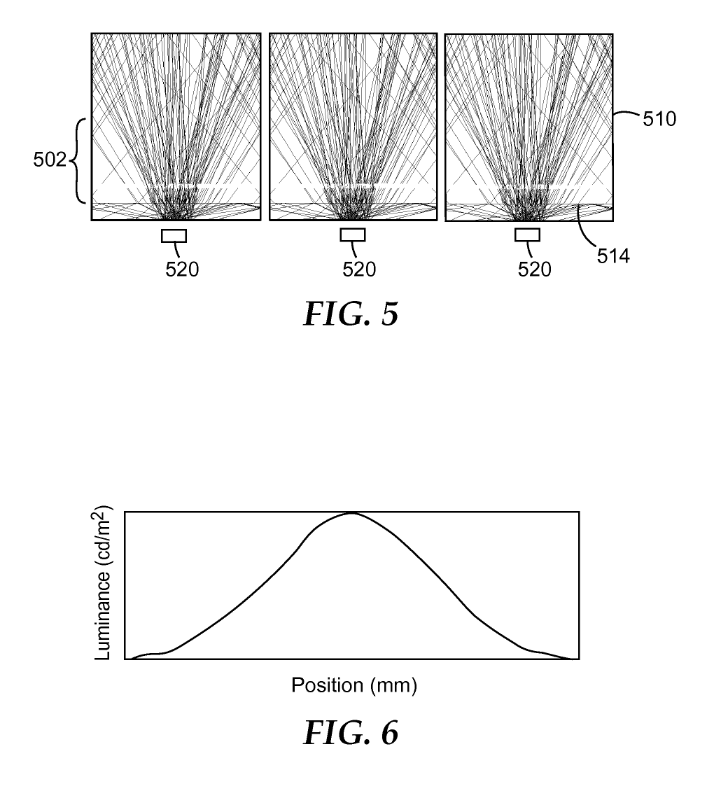

For example, FIG. 5 represents several modeled light rays that are emitted into a light guide 510 from three LEDs 520 that have a center-to-center spacing of 10 mm. The LEDs were positioned at a distance of 1 mm from an input surface 514 of the light guide 510. The light rays represent modeling data that were generated using standard modeling techniques. The index of refraction of the light guide was 1.49. Non-uniform region 502 was formed because of the lack of significant overlap of the light cones emitted by adjacent LEDs 520, a phenomenon known as “headlighting.”

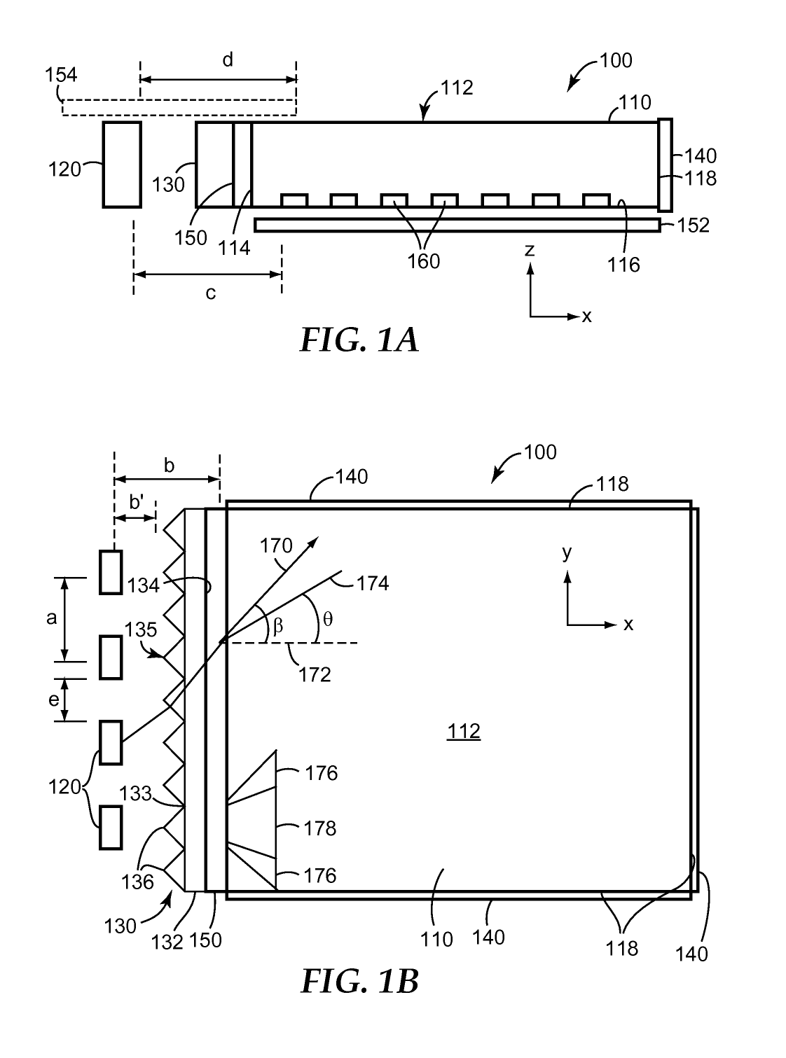

The extent of this non-uniform region near the input surface of the light guide is determined by the refractive index of the guide n_{guide} (which determines a TIR angle in the guide θ_{TIR}) and the spacing of the LEDs, D_{LED} (corresponding to distance e in FIG. 1B) using the following equation:

$$L = \frac{{D}_{LED}}{2 tan ( {θ}_{TIR} )} .$$

Because LED efficiency is continuously improving, the number of LEDs required to deliver a target average brightness value for the assembly keeps decreasing. In addition, using fewer LEDs on one edge of the light guide can have significant cost and thermal advantages. Using fewer LEDs, however, presents a new problem. As the number of LEDs decreases, the spacing D_{LED} between the LEDs increases, and the extent of the non-uniform region L becomes too large to be acceptable for most applications, e.g., LED LCDs. This is known as the “uniformity constraint.”

The illumination assemblies of the present disclosure are designed to decrease the size of the non-uniform region near the input surface of the light guide by more effectively spreading the light in the plane of the light guide. As a result, the disclosed assemblies can enable a significant increase in D_{LED}.

FIGS. 1A-B are schematic cross section and plan views of one embodiment of an illumination assembly 100. The illumination assembly 100 includes a light guide 110 that has an output surface 112 and an input surface 114 along at least one edge of the light guide that is substantially orthogonal to the output surface; a plurality of light sources 120 positioned to direct light into the light guide through the input surface; and a structured surface layer 130 positioned between the plurality of light sources and input surface. In the illustrated embodiment, the input surface extends along a y-axis, and the plurality of light sources is disposed along an axis that is substantially parallel to the y-axis. In some embodiments, the light sources 120 are operable to direct light through the structured surface layer 130 and into the light guide 110 through the input surface 114.

The structured surface layer 130 includes a substrate 132 and a plurality of structures 136 on a first surface 133 of the substrate facing the plurality of light sources 120. The input surface extends along a y-axis. In some embodiments, the plurality of structures 136 includes a refractive index n₁ that is different from a refractive index n₂ of the light guide 110 as is further described herein.

The light guide 110 of assembly 100 can include any suitable light guide, e.g., hollow or solid light guide. Although the light guide 110 is illustrated as being planar in shape, the light guide may take any suitable shape, e.g., wedge, cylindrical, planar, conical, complex molded shapes, etc. The light guide 110 can also have any suitable shape in the x-y plane, e.g., rectangular, polygonal, curved, etc. Further, the input surface 114 and/or the output surface 112 of the light guide 110 may include any suitable shapes, e.g., those described above for the shape of the light guide 110. The light guide 110 is configured to direct light through its output surface 112.

Further, the light guide 110 may include any suitable material or materials. For example, the light guide 110 may include glass; acrylates, including polymethylmethacrylate, polystyrene, fluoropolymers; polyesters including polyethylene terephthalate (PET), polyethylene naphthalate (PEN), and copolymers containing PET or PEN or both; polyolefins including polyethylene, polypropylene, polynorborene, polyolefins in isotactic, atactic, and syndiotactic sterioisomers, and polyolefins produced by metallocene polymerization. Other suitable polymers include polycarbonate, polystyrene, styrene methacrylate conpolymer and blends, cycloolefin polymers (e.g., ZEONEX and ZEONOR available from Zeon Chemicals L.P., Louisville, Ky.), polyetheretherketones and polyetherimides.

Positioned proximate the input surface 114 of light guide 110 is the plurality of light sources 120. The light sources 120 are positioned to direct light into the light guide 110 through the input surface 114. Although depicted as having one or more light sources 120 positioned along one side or edge of the light guide 110, light sources can be positioned along two, three, four, or more sides of the light guide. For example, for a rectangularly shaped light guide 110, one or more light sources 120 can be positioned along each of the four sides of the light guide. In the illustrated embodiments, the light sources are disposed along the y-axis.

The light sources 120 are shown schematically. In most cases, these sources 120 are compact light emitting diodes (LEDs). In this regard, “LED” refers to a diode that emits light, whether visible, ultraviolet, or infrared. It includes incoherent encased or encapsulated semiconductor devices marketed as “LEDs,” whether of the conventional or super radiant variety. If the LED emits non-visible light such as ultraviolet light, and in some cases where it emits visible light, it is packaged to include a phosphor (or it may illuminate a remotely disposed phosphor) to convert short wavelength light to longer wavelength visible light, in some cases yielding a device that emits white light.

An “LED die” is an LED in its most basic form, i.e., in the form of an individual component or chip made by semiconductor processing procedures. The component or chip can include electrical contacts suitable for application of power to energize the device. The individual layers and other functional elements of the component or chip are typically formed on the wafer scale, and the finished wafer can then be diced into individual piece parts to yield a multiplicity of LED dies.

Multicolored light sources, whether or not used to create white light, can take many forms in a light assembly, with different effects on color and brightness uniformity of the light guide output area or surface. In one approach, multiple LED dies (e.g., a red, a green, and a blue light emitting die) are all mounted in close proximity to each other on a lead frame or other substrate, and then encased together in a single encapsulant material to form a single package, which may also include a single lens component. Such a source can be controlled to emit any one of the individual colors, or all colors simultaneously. In another approach, individually packaged LEDs, with only one LED die and one emitted color per package, can be clustered together for a given recycling cavity, the cluster containing a combination of packaged LEDs emitting different colors such as blue/yellow, red/green/blue, red/green/blue/white, or red/green/blue/cyan/yellow. Amber LEDs can also be used. In still another approach, such individually packaged multicolored LEDs can be positioned in one or more lines, arrays, or other patterns.

LED efficiency is temperature dependent and generally decreases with increasing temperature. This efficiency decrease may be different for different types of LEDs. For example, red LEDs exhibit a significantly greater efficiency decrease than blue or green. Various embodiments of the present disclosure can be used to mitigate this effect if the more thermally sensitive LEDs are thermally isolated so that they have a lower watt density on the heat sink, and/or are not subject to heat transfer from the other LEDs. In a conventional lighting assembly, locating a cluster of one color of LEDs would result in poor color uniformity. In the present disclosure, the color, for example of a cluster of reds can mix well with green and blue LEDs to form white.

A light sensor and feedback system can be used to detect and control the brightness and/or color of light from the LEDs. For example, a sensor can be located near individual or clusters of LEDs to monitor output and provide feedback to control, maintain, or adjust a white point or color temperature. It may be beneficial to locate one or more sensors along the edge or within the hollow cavity to sample the mixed light. In some instances it may be beneficial to provide a sensor to detect ambient light outside the display in the viewing environment, for example, the room in which the display is located. In such a case, control logic can be used to appropriately adjust the display light source output based on ambient viewing conditions. Many types of sensors can be used such as light-to-frequency or light-to-voltage sensors available from Texas Advanced Optoelectronic Solutions, Plano, Tex. Additionally, thermal sensors can be used to monitor and control the output of LEDs. All of these techniques can be used to adjust the white point or color temperature based on operating conditions and based on compensation of component aging over time. Sensors can be used for dynamic contrast or field sequential systems to supply feedback signals to the control systems.

If desired, other visible light emitters such as linear cold cathode fluorescent lamps (CCFLs) or hot cathode fluorescent lamps (HCFLs) can be used instead of or in addition to discrete LED sources as illumination sources for the disclosed backlights. In addition, hybrid systems such as, for example, (CCFL/LED), including cool white and warm white, CCFL/HCFL, such as those that emit different spectra, may be used. The combinations of light emitters may vary widely, and include LEDs and CCFLs, and pluralities such as, for example, multiple CCFLs, multiple CCFLs of different colors, and LEDs and CCFLs. The light sources may also include lasers, laser diodes, plasma light sources, or organic light emitting diodes, either alone or in combination with other types of light sources, e.g., LEDs.

For example, in some applications it may be desirable to replace the row of discrete light sources with a different light source such as a long cylindrical CCFL, or with a linear surface emitting light guide emitting light along its length and coupled to a remote active component (such as an LED die or halogen bulb), and to do likewise with other rows of sources. Examples of such linear surface emitting light guides are disclosed in U.S. Pat. Nos. 5,845,038 (Lundin et al.) and 6,367,941 (Lea et al.). Fiber-coupled laser diode and other semiconductor emitters are also known, and in those cases the output end of the fiber optic waveguide can be considered to be a light source with respect to its placement in the disclosed recycling cavities or otherwise behind the output area of the backlight. The same is also true of other passive optical components having small emitting areas such as lenses, deflectors, narrow light guides, and the like that give off light received from an active component such as a bulb or LED die. One example of such a passive component is a molded encapsulant or lens of a side-emitting packaged LED.

Any suitable side-emitting LED can be used for one or more light sources, e.g., Luxeon™ LEDs (available from Lumileds, San Jose, Calif.), or the LEDs described, e.g., in U.S. patent application Ser. No. 11/381,324 (Leatherdale et al.), entitled LED Package with Converging Optical Element; and U.S. patent application Ser. No. 11/381,293 (Lu et al.), entitled LED PACKAGE WITH WEDGE-SHAPED OPTICAL ELEMENT. Other emission patterns may be desired for various embodiments described herein. See, e.g., U.S. Patent Publication No. 2007/0257270 (Lu et al.), entitled LED Package with Wedge-shaped Optical Element.

In some embodiments where the illumination assemblies are used in combination with a display panel (e.g., panel 490 of FIG. 4), the assembly 100 continuously emits white light, and the LC panel is combined with a color filter matrix to form groups of multicolored pixels (such as yellow/blue (YB) pixels, red/green/blue (RGB) pixels, red/green/blue/white (RGBW) pixels, red/yellow/green/blue (RYGB) pixels, red/yellow/green/cyan/blue (RYGCB) pixels, or the like) so that the displayed image is polychromatic. Alternatively, polychromatic images can be displayed using color sequential techniques, where, instead of continuously back-illuminating the LC panel with white light and modulating groups of multicolored pixels in the LC panel to produce color, separate differently colored light sources within the assembly (selected, for example, from red, orange, amber, yellow, green, cyan, blue (including royal blue), and white in combinations such as those mentioned above) are modulated such that the assembly flashes a spatially uniform colored light output (such as, for example, red, then green, then blue) in rapid repeating succession. This color-modulated assembly is then combined with a display module that has only one pixel array (without any color filter matrix), the pixel array being modulated synchronously with the assembly to produce the whole gamut of achievable colors (given the light sources used in the backlight) over the entire pixel array, provided the modulation is fast enough to yield temporal color-mixing in the visual system of the observer. Examples of color sequential displays, also known as field sequential displays, are described in U.S. Pat. Nos. 5,337,068 (Stewart et al.) and 6,762,743 (Yoshihara et al.). In some cases, it may be desirable to provide only a monochrome display. In those cases the illumination assemblies can include filters or specific sources that emit predominantly in one visible wavelength or color.

In some embodiments, the light sources 120 can include one or more polarized sources. In such embodiments, it may be preferred that a polarization axis of the polarized sources is oriented such that it is substantially parallel with a pass axis of the front reflector; alternatively it may be preferred that the source polarization axis is substantially perpendicular to the pass axis of the front reflector. In other embodiments, the polarization axis may form any suitable angle relative to the pass axis of the front reflector.

The light sources 120 may be positioned in any suitable arrangement. Further, the light sources 120 can include light sources that emit different wavelengths or colors of light. For example, the light sources may include a first light source that emits a first wavelength of light, and a second light source that emits a second wavelength of light. The first wavelength may be the same as or different from the second wavelength. The light sources 120 may also include a third light source that emits a third wavelength of light. In some embodiments, the various light sources 120 may produce light that, when mixed, provides white light to a display panel or other device. In other embodiments, the light sources 210 may each produce white light.

Further, in some embodiments, light sources that at least partially collimate the emitted light may be preferred. Such light sources can include lenses, extractors, shaped encapsulants, or combinations thereof of optical elements to provide a desired output into the hollow light recycling cavity of the disclosed backlights. Further, the illumination assemblies of the present disclosure can include injection optics that partially collimate or confine light initially injected into the recycling cavity.

The light sources 120 can be positioned any suitable distance b from the input surface 114 of the light guide 110. For example, in some embodiments, the light sources 120 can be positioned within 5 mm, 2 mm, 1 mm, 0.5 mm, or less of the input surface 114. Further, the light sources 120 can be positioned within any suitable distance b′ from the plurality of structures 136 of the structured surface layer 130, e.g., 5 mm, 2 mm, 1 mm, 0.5 mm, or less.

The light sources 120 can be spaced apart along the y-axis any suitable distance to provide in combination with the structured surface layer 130 any desired light distribution within the light guide 110. For example, the light sources 120 may have a center-to-center spacing a (i.e., pitch) of at least 5 mm, 10 mm, 15 mm, 20 mm, 25 mm, 30 mm, or greater as is further described herein. The light sources 120 can be positioned such that a primary emitting surface of one light source is any suitable distance e from a primary emitting surface of an adjacent light source, e.g., at least 5 mm, 10 mm, 15 mm, 20 mm, 25 mm, 30 mm, or greater.

Positioned between the plurality of light sources 120 and the input surface 114 of the light guide 110 is the structured surface layer 130. In the embodiment illustrated in FIGS. 1A-B, the structured surface layer 130 includes a substrate 132 that includes a first surface 133 facing the light sources 120, and a second surface 134 facing the input surface 114 of the light guide 110. The layer 130 also includes a plurality of structures 136 positioned on the first surface 133 of the substrate 132 facing the plurality of light sources 120. The structures 136 form a structured surface 135. Although the structured surface layer 130 is illustrated as being positioned proximate one edge of the light guide 110, a structured surface layer 130 may also be positioned proximate two, three, four, or more edges 118 of the light guide 110 in conjunction with additional light sources 120 to provide a desired light distribution within the light guide 110.

Useful polymeric film materials that may be used as the substrate 132 include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, and polyimides. Optionally, the substrate material can contain mixtures or combinations of these materials. In some embodiments, the substrate may be multi-layered or may contain a dispersed component suspended or dispersed in a continuous phase.

In some embodiments, substrate materials can include polyethylene terephthalate (PET) and polycarbonate. Examples of useful PET films include photograde polyethylene terephthalate and MELINEX PET (available from DuPont Films, Wilmington, Del.)

Some substrate materials can be optically active, and can act as polarizing materials.

A number of bases, also referred to herein as films or substrates, are known in the optical product art to be useful as polarizing materials. Polarization of light through a film can be accomplished, for example, by the inclusion of dichroic polarizers in a film material that selectively absorbs passing light. Light polarization can also be achieved by including inorganic materials such as aligned mica chips or by a discontinuous phase dispersed within a continuous film, such as droplets of light modulating liquid crystals dispersed within a continuous film. As an alternative, a film can be prepared from microfine layers of different materials. The polarizing materials within the film can be aligned into a polarizing orientation, for example, by employing methods such as stretching the film, applying electric or magnetic fields, and suitable coating techniques.

Examples of polarizing films include those described in U.S. Pat. Nos. 5,825,543 (Ouderkirk et al.) and 5,783,120 (Ouderkirk et al.). The use of these polarizer films in combination with a brightness enhancement film has been described, e.g., in U.S. Pat. No. 6,111,696 (Ouderkirk et al.). A second example of a polarizing film that can be used as a base are those films described in U.S. Pat. No. 5,882,774 (Jonza et al.). Films available commercially are the multilayer films sold under the trade designation DBEF (Dual Brightness Enhancement Film) from 3M. The use of such multilayer polarizing optical films in a brightness enhancement film has been described, e.g., in U.S. Pat. No. 5,828,488 (Ouderkirk et al.). In other embodiments the substrate may act as a color selective reflector as described in U.S. Pat. No. 6,531,230 (Weber et al.).

The substrate 132 can include any suitable thickness, e.g., at least 0.5 mils, 0.6 mils, 0.7 mils, 0.8 mils, 0.9 mils, or greater. In some embodiments, the substrate thickness ranges from about 1 mil to 5 mils.

The plurality of structures 136 are positioned on or in the first surface 133 of the substrate 132. The structures 136 face the light sources 120. The structures 136 can include any suitable structures or elements that provide the desired light distribution in the light guide 110. In some embodiments, the structures 136 are operable to spread light in the plane of the light guide 110 (i.e., the x-y plane). The structures 136 can include refractive or diffractive structures. Further, the structures can be any suitable shape and size, and have any suitable pitch.

The structures 136 can take any suitable cross-sectional shape, e.g., triangular, spherical, aspherical, polygonal, etc. Further, in some embodiments, structures 136 can be extended along the thickness direction of the light guide 110, i.e., the z-axis in FIGS. 1A-B. For example, the structures 136 can have a triangular cross-section and extend along the z-axis to form prismatic structures. In other embodiments, the structures 136 can take a lenticular shape that extends in both the z-axis and the y-axis.

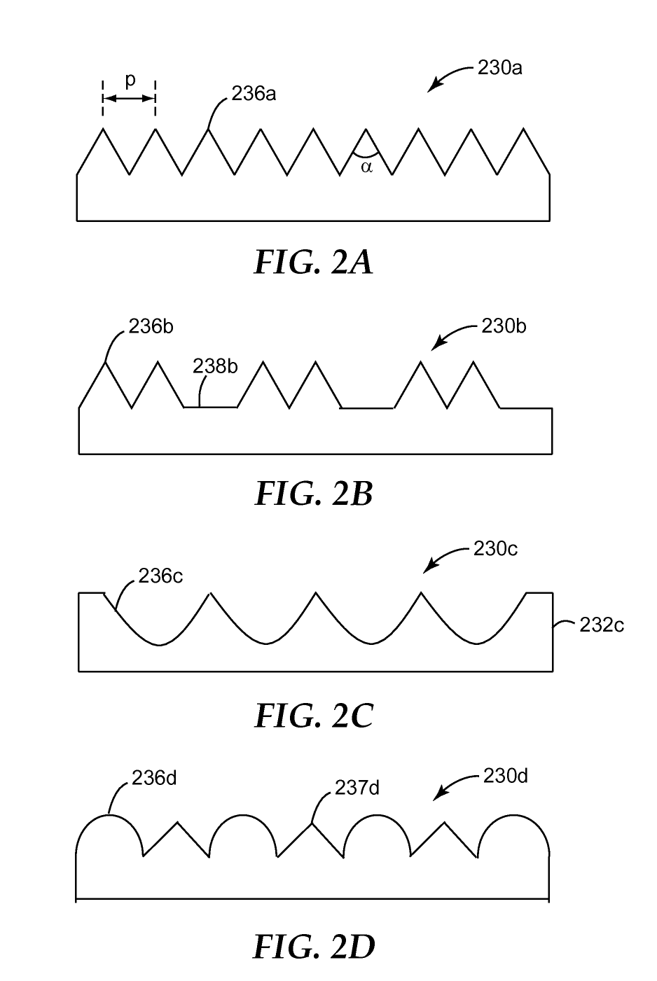

For example, FIGS. 2A-D are schematic cross-section views of several embodiments of structured surface layers. In FIG. 2A, the structured surface layer 230a includes a plurality of structures 236a each having a substantially triangular cross-section. Although layer 230a as illustrated includes structures 236a that all have substantially similar cross-sections and sizes, the structures can have a variety of sizes and shapes. The structures 236a can be extended along an axis that is substantially orthogonal to the plane of the figure (e.g., the z-axis of FIGS. 1A-B) to form prismatic structures. The structures 236a can have any suitable apex angle α. In some embodiments, the apex angle α can be at least 60 degrees. In some embodiments, the apex angle can be at least 90 degrees. In other embodiments, the apex angle can be less than 140 degrees. These structures can also have any suitable pitch p as is further described herein.

The structures 236a can be positioned on the substrate of the structured surface layer such that the structured pattern is translationally invariant across the length of the layer (i.e., along the y-axis). In other embodiments, the structures can be varied in size, shape, and/or pattern such that the structured surface layer varies along the length of the layer.

In general, the structures of the structured surface layer can be positioned continuously across the first surface of the substrate (e.g., first surface 133 of substrate 132 of FIGS. 1A-B). Alternatively, the structures can be formed such that there are non-structured regions or portions of the structured surface layer. For example, FIG. 2B is a schematic cross-section view of another embodiment of a structured surface layer 230b, where the layer includes structures 236b and regions 238b of the layer that do not include structures. These unstructured regions can be periodic or aperiodic. And the structures 236b can be grouped in any suitable pattern or arrangement with the unstructured regions 238b. In some embodiments, the unstructured regions 238b can be registered with one or more of the plurality of light sources (e.g., light sources 120 of FIGS. 1A-B) such that light along an emission axis of the light sources enters the input surface of the light guide without substantially interacting with a structure, e.g., the non-structured portions of the structured surface can provide little or no spreading of light such that more light is transported to the regions of the light guide remote from the input surface. This transport of light can provide a more uniform light flux distribution at the output surface of the light guide. In some embodiments, the non-structured regions 238b can include a reflective material positioned thereon.

The structures of the structured surface layers of the present disclosure can either extend from the substrate or into the substrate as indentations. Alternatively, the structured surface layer can include a combination of structures that both extend from and into the substrate. For example, FIG. 2C is a schematic cross-section view of another embodiment of structured surface layer 230c. The layer 230c includes a plurality of structures 236c that extend into substrate 232c and have a curved cross-sectional shape. Any suitable cross-sectional shape can be formed in the substrate to provide the desired light distribution in the light guide.

The structured surface layers of the present disclosure can have the same size and shape of structures positioned on the first surface of the substrate. Alternatively, the structured surface layer can include two or more sets of structures. For example, FIG. 2D is a schematic cross-section view of another embodiment of a structured surface layer 230d. The layer 230d includes a first set of structures 236d and a second set of structures 237d that are different from the first set of structures. First group of structures 236d includes structures having a curved or circular cross section. Each of the structures of the second set of structures 237d has a triangular cross-section. In some embodiments, the first and second sets of structures can include one or more cross sectional shapes, and the shapes of the first set of structures can have different sizes and/or pitches from the second set of structures.

The first and second set of structures can also include different arrangements or patterns. For example, one or both of the first and second sets of structures can include a repeating pattern or a non-repeating pattern.

In some embodiments, the structures may have two size scales of structures in the form of a structure on a structure. For example, the structures may include a lenticular refractive structure with a smaller structure on the surface of the refractive structure. Such structures, for example, may include refractive structures with diffractive nanostructures disposed thereon or a refractive structure with a nano structure on the surface of the refractive structure that provides an anti-reflective function.

As mentioned herein, the structures of the structured surface layer can be extended along the thickness direction of the light guide (i.e., the z-axis). In some embodiments, the axis along which the structures are extended can be oriented at any suitable angle relative to the z-axis. For example, the structures can be extended along an axis that forms an angle of greater than 0 degrees with the z-axis. In other embodiments, the structures can be extended along an axis that forms an angle of 90 degrees with the z-axis such that the structures are extended in the y-axis.

As mentioned herein, the structured surface layer 130 can include either refractive or diffractive structures. Exemplary diffractive structures include structured diffusers (e.g., LSD diffuser films, available from Luminit LLC, Torrance, Calif.).

Returning to FIGS. 1A-B, the structures 136 of the structured surfaced layer 130 can be formed from any suitable material or materials. These materials can provide any desired index of refraction value or values such that the distribution of light entering the input surface can be further tailored. For example, the structures 136 can have a refractive index n₁ that can be selected such that a relationship between the refractive index of the structures and a refractive index n₂ of the light guide 110 can have any desired relationship. For example, n₁ can be equal to or different from n₂. In some embodiments, n₁ can be greater than n₂; alternatively, n₁ can be less than n₂. In some embodiments, the difference between the two refractive indices, Δn=|n₁−n₂| can be at least 0.01 or greater.

Further, the index of refraction n₁ of the structures 136 can have any suitable relationship with an index of refraction n₄ of the substrate 132. For example, n₁ can be equal to, less than, or greater than n₄.

Any suitable material or materials can be used to form the plurality of structures 136 to provide these index of refraction relationships with the light guide 110 and other elements of the assembly 100. For example, the structures 136 can be formed from organic or inorganic high index resins. In some embodiments, the structures can be formed from high index resins that include nanoparticles, such as the resins described in U.S. Pat. No. 7,547,476 (Jones et al.). In other embodiments, the structures can be formed from UV curable acrylic resins, e.g., those described in US Patent Publication No. US 2009/0017256 A1 (Hunt et al.), and PCT Patent Publication No. WO 2010/074862 (Jones et al.).

Useful materials that may be used to form the structures 136 include, for example, thermoplastic materials such as styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, and polycyclo-olefins. Optionally, the material used to form the structures 136 may include mixtures or combinations of these materials. In some embodiments, particularly useful materials include polymethyl methacrylate, polycarbonate, styrene methacrylate and cycloolefin polymers (for example Zeonor and Zeonex available from ZEON Chemicals).

The structures may also be formed from other suitable curing materials for example epoxies, polyurethanes, polydimethylsiloxanes, poly(phenyl methyl)siloxanes, and other silicone based materials, for example, silicone polyoxamides and silicone polyureas. The structured surface layer can also include a short wavelength absorber (e.g., UV light absorber).

As is further described herein, the structured surface layer 130 can be formed using any suitable technique. For example, the structures 136 can be cast onto the substrate 132 and cured. Alternatively, the structures can be embossed into the substrate 132. Or the structures and the substrate can be made of a single material in an extrusion replication process such as that described in PCT Patent Application NO. WO/2010/117569.

In some embodiments, the structured surface layer 130 can be attached to the input surface 114 of the light guide 110 using any suitable technique. For example, the structured surface layer 130 can be attached to the input surface 114 of the light guide 110 with an adhesive layer 150. In some embodiments, the adhesive layer 150 is optically clear and colorless to provide optical coupling of the structured surface layer 130 to the light guide 110. Further, the adhesive layer 150 may preferably be non-yellowing and resistant to heat and humidity, thermal shock, etc.

The adhesive layer 150 can be formed using any suitable material or materials. In some embodiments, the adhesive layer 150 may include any suitable repositionable adhesive or pressure-sensitive adhesive (PSA).

In some embodiments, useful PSAs include those described in the Dalquist criterion line (as described in Handbook of Pressure Sensitive Adhesive Technology, Second Ed., D. Satas, ed., Van Nostrand Reinhold, New York, 1989.)

The PSA may have a particular peel force or at least exhibit a peel force within a particular range. For example, the PSA may have a 90° peel force of from about 50 to about 3000 g/in, from about 300 to about 3000 g/in, or from about 500 to about 3000 g/in. Peel force may be measured using a peel tester from IMASS.

In some embodiments, the PSA includes an optically clear PSA having high light transmittance of from about 80 to about 100%, from about 90 to about 100%, from about 95 to about 100%, or from about 98 to about 100% over at least a portion of the visible light spectrum (about 400 to about 700 nm). In some embodiments, the PSA has a haze value of less than about 5%, less than about 3%, or less than about 1%. In some embodiments, the PSA has a haze value of from about 0.01 to less than about 5%, from about 0.01 to less than about 3%, or from about 0.01 to less than about 1%. Haze values in transmission can be determined using a haze meter according to ASTM D1003.

In some embodiments, the PSA includes an optically clear adhesive having high light transmittance and a low haze value. High light transmittance may be from about 90 to about 100%, from about 95 to about 100%, or from about 99 to about 100% over at least a portion of the visible light spectrum (about 400 to about 700 nm), and haze values may be from about 0.01 to less than about 5%, from about 0.01 to less than about 3%, or from about 0.01 to less than about 1%.

In some embodiments, the PSA is hazy and diffuses light, particularly visible light. A hazy PSA may have a haze value of greater than about 5%, greater than about 20%, or greater than about 50%. A hazy PSA may have a haze value of from about 5 to about 90%, from about 5 to about 50%, or from about 20 to about 50%. The haze that diffuses the light should in some preferred embodiments be primarily forward scattering, meaning that little light is scattered back toward the originating light source.

The PSA may have a refractive index in the range of from about 1.3 to about 2.6, 1.4 to about 1.7, or from about 1.5 to about 1.7. The particular refractive index or range of refractive indices selected for the PSA may depend on the overall design of the optical tape.

The PSA generally includes at least one polymer. PSAs are useful for adhering together adherends and exhibit properties such as: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process. A quantitative description of PSAs can be found in the Dahlquist reference cited herein.

Exemplary poly(meth)acrylate PSAs are derived from: monomer A including at least one monoethylenically unsaturated alkyl (meth)acrylate monomer and which contributes to the flexibility and tack of the PSA; and monomer B including at least one monoethylenically unsaturated free-radically copolymerizable reinforcing monomer which raises the Tg of the PSA and contributes to the cohesive strength of the PSA. Monomer B has a homopolymer glass transition temperature (Tg) higher than that of monomer A. As used herein, (meth)acrylic refers to both acrylic and methacrylic species and likewise for (meth)acrylate.

Preferably, monomer A has a homopolymer Tg of no greater than about 0° C. Preferably, the alkyl group of the (meth)acrylate has an average of about 4 to about 20 carbon atoms. Examples of monomer A include 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate. The alkyl group can comprise ethers, alkoxy ethers, ethoxylated or propoxylated methoxy (meth)acrylates. Monomer A may comprise benzyl acrylate.

Preferably, monomer B has a homopolymer Tg of at least about 10° C., for example, from about 10 to about 50° C. Monomer B may comprise (meth)acrylic acid, (meth)acrylamide and N-monoalkyl or N-dialkyl derivatives thereof, or a (meth)acrylate. Examples of monomer B include N-hydroxyethyl acrylamide, diacetone acrylamide, N,N-dimethyl acrylamide, N,N-diethyl acrylamide, N-ethyl-N-aminoethyl acrylamide, N-ethyl-N-hydroxyethyl acrylamide, N,N-dihydroxyethyl acrylamide, t-butyl acrylamide, N,N-dimethylaminoethyl acrylamide, and N-octyl acrylamide. Other examples of monomer B include itaconic acid, crotonic acid, maleic acid, fumaric acid, 2,2-(diethoxy)ethyl acrylate, 2-hydroxyethyl acrylate or methacrylate, 3-hydroxypropyl acrylate or methacrylate, methyl methacrylate, isobornyl acrylate, 2-(phenoxy)ethyl acrylate or methacrylate, biphenylyl acrylate, t-butylphenyl acrylate, cyclohexyl acrylate, dimethyladamantyl acrylate, 2-naphthyl acrylate, phenyl acrylate, N-vinyl formamide, N-vinyl acetamide, N-vinyl pyrrolidone, and N-vinyl caprolactam.

In some embodiments, the (meth)acrylate PSA is formulated to have a resultant Tg of less than about 0° C. and more preferably, less than about −10° C. Such (meth)acrylate PSAs include about 60 to about 98% by weight of at least one monomer A and about 2 to about 40% by weight of at least one monomer B, both relative to the total weight of the (meth)acrylate PSA copolymer.

Useful PSAs include natural rubber-based and synthetic rubber-based PSAs. Rubber-based PSAs include butyl rubber, copolymers of isobutylene and isoprene, polyisobutylene, homopolymers of isoprene, polybutadiene, and styrene/butadiene rubber. These PSAs may be inherently tacky or they may require tackifiers. Tackifiers include rosins and hydrocarbon resins.

Useful PSAs include thermoplastic elastomers. These PSAs include styrene block copolymers with rubbery blocks of polyisoprene, polybutadiene, poly(ethylene/butylene), poly(ethylene-propylene. Resins that associate with the rubber phase may be used with thermoplastic elastomer PSAs if the elastomer itself is not tacky enough. Examples of rubber phase associating resins include aliphatic olefin-derived resins, hydrogenated hydrocarbons, and terpene phenolic resins. Resins that associate with the thermoplastic phase may be used with thermoplastic elastomer PSAs if the elastomer is not stiff enough. Thermoplastic phase associating resins include polyaromatics, coumarone-indene resins, resins derived from coal tar or petroleum.

Useful PSAs include tackified thermoplastic-epoxy pressure sensitive adhesives as described in U.S. Pat. No. 7,005,394 (Ylitalo et al.). These PSAs include thermoplastic polymer, tackifier and an epoxy component.

Useful PSAs include polyurethane pressure sensitive adhesive as described in U.S. Pat. No. 3,718,712 (Tushaus). These PSAs include crosslinked polyurethane and a tackifier.

Useful PSAs include polyurethane acrylate as described in US 2006/0216523 (Shusuke). These PSAs include urethane acrylate oligomer, plasticizer and an initiator.

Useful PSAs include silicone PSAs such as polydiorganosiloxanes, polydiorganosiloxane polyoxamides and silicone urea block copolymers described in U.S. Pat. No. 5,214,119 (Leir, et al). The silicone PSAs may be formed from a hyrosilylation reaction between one or more components having silicon-bonded hydrogen and aliphatic unsaturation. The silicone PSAs may include a polymer or gum and an optional tackifying resin. The tackifying resin may comprise a three-dimensional silicate structure that is endcapped with trialkylsiloxy groups.

Useful silicone PSAs may also include a polydiorganosiloxane polyoxamide and an optional tackifier as described in U.S. Pat. No. 7,361,474 (Sherman et al.) incorporated herein by reference. Useful tackifiers include silicone tackifying resins as described in U.S. Pat. No. 7,090,922 B2 (Zhou et al.) incorporated herein by reference.

The PSA may be crosslinked to build molecular weight and strength of the PSA. Crosslinking agents may be used to form chemical crosslinks, physical crosslinks or a combination thereof, and they may be activated by heat, UV radiation and the like.

In some embodiments, the PSA is formed from a (meth)acrylate block copolymer as described in U.S. Pat. No. 7,255,920 B2 (Everaerts et al.). In general, these (meth)acrylate block copolymers comprise: at least two A block polymeric units that are the reaction product of a first monomer composition including an alkyl methacrylate, an aralkyl methacrylate, an aryl methacrylate, or a combination thereof, each A block having a Tg of at least 50° C., the methacrylate block copolymer including from 20 to 50 weight percent A block; and at least one B block polymeric unit that is the reaction product of a second monomer composition including an alkyl (meth)acrylate, a heteroalkyl (meth)acrylate, a vinyl ester, or a combination thereof, the B block having a Tg no greater than 20° C., the (meth)acrylate block copolymer including from 50 to 80 weight percent B block; wherein the A block polymeric units are present as nanodomains having an average size less than about 150 nm in a matrix of the B block polymeric units.

In some embodiments, the adhesive includes a clear acrylic PSA, for example, those available as transfer tapes such as VHB™ Acrylic Tape 4910F from 3M Company and 3M™ Optically Clear Laminating Adhesives (8140 and 8180 series), 3M™ Optically Clear laminating adhesives (8171 CL and 8172 CL) described in PCT patent publication 2004/0202879. Other exemplary adhesives are described in case number 63534US002.

In some embodiments, the adhesive includes a PSA formed from at least one monomer containing a substituted or an unsubstituted aromatic moiety as described in U.S. Pat. No. 6,663,978 B1 (Olson et al.).

In some embodiments, the PSA includes a copolymer as described in U.S. Ser. No. 11/875,194 (63656US002, Determan et al.), including (a) monomer units having pendant biphenyl groups and (b) alkyl (meth)acrylate monomer units.

In some embodiments, the PSA includes a copolymer as described in U.S. Provisional Application Ser. No. 60/983,735 (63760US002, Determan et al.), including (a) monomer units having pendant carbazole groups and (b) alkyl (meth)acrylate monomer units.

In some embodiments, the adhesive includes an adhesive as described in U.S. Provisional Application Ser. No. 60/986,298 (63108US002, Schaffer et al.), including a block copolymer dispersed in an adhesive matrix to form a Lewis acid-base pair. The block copolymer includes an AB block copolymer, and the A block phase separates to form microdomains within the B block/adhesive matrix. For example, the adhesive matrix may comprise a copolymer of an alkyl (meth)acrylate and a (meth)acrylate having pendant acid functionality, and the block copolymer may comprise a styrene-acrylate copolymer. The microdomains may be large enough to forward scatter incident light, but not so large that they backscatter incident light. Typically these microdomains are larger than the wavelength of visible light (about 400 to about 700 nm). In some embodiments the microdomain size is from about 1.0 to about 10 um.

The adhesive may comprise a stretch releasable PSA. Stretch releasable PSAs are PSAs that can be removed from a substrate if they are stretched at or nearly at a zero degree angle. In some embodiments, the adhesive or a stretch release PSA used as in the optical tape has a shear storage modulus of less than about 10 MPa when measured at 1 rad/sec and −17° C., or from about 0.03 to about 10 MPa when measured at 1 rad/sec and −17° C. Stretch releasable PSAs may be used if disassembling, reworking, or recycling is desired.

In some embodiments, the stretch releasable PSA may comprise a silicone-based PSA as described in U.S. Pat. No. 6,569,521 B1 (Sheridan et al.) or U.S. Provisional Application Nos. 61/020,423 (63934US002, Sherman et al.) and 61/036,501 (64151US002, Determan et al.). Such silicone-based PSAs include compositions of an MQ tackifying resin and a silicone polymer. For example, the stretch releasable PSA may comprise an MQ tackifying resin and an elastomeric silicone polymer selected from the group consisting of urea-based silicone copolymers, oxamide-based silicone copolymers, amide-based silicone copolymers, urethane-based silicone copolymers, and mixtures thereof.

In some embodiments, the stretch releasable PSA may comprise an acrylate-based PSA as described in U.S. Provisional Application Nos. 61/141,767 (64418US002, Yamanaka et al.) and 61/141,827 (64935US002, Tran et al.) Such acrylate-based PSAs include compositions of an acrylate, an inorganic particle and a crosslinker. These PSAs can be a single or multilayer.

The PSA and/or the structured surface layer can optionally include one or more additives such as filler, particles, plasticizers, chain transfer agents, initiators, antioxidants, stabilizers, viscosity modifying agents, antistats, fluorescent dyes and pigments, phosphorescent dyes and pigments, quantum dots, and fibrous reinforcing agents.

The adhesive may be made hazy and/or diffusive by including particles such as nanoparticles (diameter less than about 1 um), microspheres (diameter 1 um or greater), or fibers. Exemplary nanoparticles include TiO₂. In some embodiments, the viscoelastic lightguide may comprise a PSA matrix and particles as described in U.S. Provisional Application No. 61/097,685 (Attorney Docket No. 64740US002), including a optically clear PSA and silicone resin particles having a refractive index less than that of the PSA, and incorporated herein by reference.

In some embodiments it may be desirable for the PSA to have a microstructured adhesive surface to allow for air bleed upon application to the edge of the light guide. Methods for attachment of optical PSAs having air bleed are described in US publication number 2007/0212535.

The adhesive layer may comprise the cured reaction product of a multifunctional ethylenically unsaturated siloxane polymer and one or more vinyl monomers as described in US 2007/0055019 A1 (Sherman et al.; Attorney Docket No. 60940US002) and US 2007/0054133 A1 (Sherman et al.; Attorney Docket No. 61166US002).

The adhesive layer may comprise a PSA such that the layer exhibits aggressive tack when applied with little or no added pressure. PSAs are described in the Dalquist criterion line (as described in Handbook of Pressure Sensitive Adhesive Technology, Second Ed., D. Satas, ed., Van Nostrand Reinhold, New York, 1989). Useful PSAs include those based on natural rubbers, synthetic rubbers, styrene block copolymers, (meth)acrylic block copolymers, polyvinyl ethers, polyolefins, and poly(meth)acrylates. As used herein, (meth)acrylic refers to both acrylic and methacrylic species and likewise for (meth)acrylate.

An exemplary PSA includes a polymer derived from an oligomer and/or monomer including polyether segments, wherein from 35 to 85% by weight of the polymer includes the segments. These adhesives are described in US 2007/0082969 A1 (Malik et al.). Another exemplary PSA includes the reaction product of a free radically polymerizable urethane-based or urea-based oligomer and a free radically polymerizable segmented siloxane-based copolymer; these adhesives are described in U.S. Provisional Application 61/410,510 (Attorney Docket No. 67015US002).

In some cases, the adhesive layer includes an adhesive that does not contain silicone. Silicones comprise compounds having Si—O and/or Si—C bonds. An exemplary adhesive includes a non-silicone urea-based adhesive prepared from curable non-silicone urea-based oligomers as described in PCT Patent Publication No. WO 2009/085662 (Attorney Docket No. 63704WO003). A suitable non-silicone urea-based adhesive may comprise an X—B—X reactive oligomer and ethylenically unsaturated monomers. The X—B—X reactive oligomer includes X as an ethylenically unsaturated group, and B as a non-silicone segmented urea-based unit having at least one urea group. In some embodiments, the adhesive layer is not microstructured.

Another exemplary adhesive includes a non-silicone urethane-based adhesive as described in International Application No. PCT/US2010/031689 (Attorney Docket No. 65412WO003). A suitable urethane-based adhesive may comprise an X-A-B-A-X reactive oligomer and ethylenically unsaturated monomers. The X-A-B-A-X reactive oligomer includes X as an ethylenically unsaturated group, B as a non-silicone unit with a number average molecular weight of 5,000 grams/mole or greater, and A as a urethane linking group.

Further, the adhesive layer 150 may include a microstructured surface on the second surface 134 that faces the input edge 114 to allow for air to be directed through the microstructured surface such that air bubbles are less likely to be trapped between the adhesive layer 150 and the input surface 114.

In some embodiments, the adhesive layer 150 can be selected such that it acts to planarize the input surface 114 of the light guide 110 such that little or no diffusion of light occurs at this interface. In these embodiments, the manufacturing of the light guide 110 may be simplified because the input surface 114 would not necessarily need to be polished prior to attachment of the structured surface layer 130.

The adhesive layer 150 can have any desired index of refraction n₃. For example, n₃ can be less than, equal to, or greater than the index of refraction n₁ of the plurality of structures 136 of the structured surface layer 130. Also, n₃ can be less than, equal to, or greater than the index of refraction n₂ of the light guide 110.

Because the structured surface layer 130 can direct light into the light guide 110 at angles to a normal of the input surface in the plane of the light guide (i.e., the x-y plane) that are greater than the TIR angle of light guide 110, some injected light can be incident upon one or more edges 118 of the light guide at angles that are less than the TIR angle and, therefore, leave the light guide. This leakage of light may reduce the uniformity of the light being directed through the output surface 112 (i.e., the output light flux distribution) because an undesired amount of light may not be transported in the light guide away from the input surface 114. The leakage of light can also lead to reduced efficiency for the illumination assembly 100.

To help prevent this leakage of light, one or more side reflectors 140 can be positioned proximate one or more edges 118 of the light guide 110 to reflect the leaking light back into the light guide 110. The side reflectors 140 can include any suitable type or types of reflectors. For example, the side reflectors 140 can be specularly reflective, semi-specularly reflective, or diffusely reflective. In some embodiments, the side reflectors may include a dielectric multilayer optical film that reflects light of at least one polarization, e.g., Enhanced Specular Reflector Film (ESR film) available from 3M Company, St. Paul, Minn. The side reflectors can include the same reflectors as described herein regarding back reflector 152 and can be attached or detached to the light guide.

The side reflectors 140 can, in some embodiments, be attached to one or more edges 118 of the light guide 110 using any suitable technique. For example, the side reflectors 140 can be attached to one or more edges 118 using an adhesive layer (not shown) similar to the adhesive layer 150 described herein. The adhesive layer can be selected such that it planarizes the edges 118, thereby simplifying the manufacture of the light guide 110 by allowing the edges to remain unpolished. For embodiments where the side reflectors 140 include multilayer optical film reflectors, it may be advantageous for the reflector to have disposed between its surface and the edge 118 of the light guide 112 a low index layer as described, e.g., in U.S. Patent Application No. 61/405,141 (Attorney Docket No. 66153US002).

The illumination assembly 110 can also include a back reflector 152. The back reflector 152 is preferably highly reflective. For example, the back reflector 152 can have an on-axis average reflectivity for visible light emitted by the light sources of at least 90%, 95%, 98%, 99%, or more for visible light of any polarization. Such reflectivity values also can reduce the amount of loss in a highly recycling cavity. Such reflectivity values encompass all visible light reflected into a hemisphere, i.e., such values include both specular and diffuse reflections.

The back reflector 152 can be a predominantly specular, diffuse, or combination specular/diffuse reflector, whether spatially uniform or patterned. In some embodiments, the back reflector 152 can be a semi-specular reflector as described in PCT Patent Application No. WO2008/144644, entitled RECYCLING BACKLIGHTS WITH BENEFICIAL DESIGN CHARACTERISTICS; and U.S. patent application Ser. No. 11/467,326 (Ma et al.), entitled BACKLIGHT SUITABLE FOR DISPLAY DEVICES.

In some cases, the back reflector 152 can be made from a stiff metal substrate with a high reflectivity coating, or a high reflectivity film laminated to a supporting substrate. Suitable high reflectivity materials include Enhanced Specular Reflector (ESR) multilayer polymeric film; a film made by laminating a barium sulfate-loaded polyethylene terephthalate film (2 mils thick) to ESR film using a 0.4 mil thick isooctylacrylate acrylic acid pressure sensitive adhesive, the resulting laminate film referred to herein as “EDR II” film; E-60 series Lumirror™ polyester film available from Toray Industries, Inc.; porous polytetrafluoroethylene (PTFE) films, such as those available from W. L. Gore & Associates, Inc.; Spectralon™ reflectance material available from Labsphere, Inc.; Miro™ anodized aluminum films (including Miro™ 2 film) available from Alanod Aluminum-Veredlung GmbH & Co.; MCPET high reflectivity foamed sheeting from Furukawa Electric Co., Ltd.; White Refstar™ films and MT films available from Mitsui Chemicals, Inc.; and 2xTIPS (see Examples for description).

The back reflector 152 can be substantially flat and smooth, or it may have a structured surface associated with it to enhance light scattering or mixing. Such a structured surface can be imparted (a) on the surface of the back reflector 152, or (b) on a transparent coating applied to the surface. In the former case, a highly reflecting film may be laminated to a substrate in which a structured surface was previously formed, or a highly reflecting film may be laminated to a flat substrate (such as a thin metal sheet, as with Durable Enhanced Specular Reflector-Metal (DESR-M) reflector, available from 3M Company) followed by forming the structured surface, such as with a stamping operation. In the latter case, a transparent film having a structured surface can be laminated to a flat reflective surface, or a transparent film can be applied to the reflector and then afterwards a structured surface can be imparted to the top of the transparent film. In some embodiments, the back reflector may be attached to the bottom surface of the light guide. Further, in some embodiments it may be advantageous or beneficial for there to be an optical film (e.g., a reflective polarizing film) attached to the exit surface 112 of the light guide as described in U.S. Patent Application No. 61/267,631 (Attorney Docket No. 65796US002) and PCT Patent Application No. US2010/053655 (Attorney Docket No. 65900WO004).

Further, the backlights of the present disclosure can include injection optics (not shown) that can direct light from the plurality of light sources 120 toward the input surface 114 of the light guide 110. In some embodiments, the injection optics can be operable to partially collimate or confine light initially injected into the light guide 110 to propagation directions close to a transverse plane (the transverse plane being parallel to the output surface 110 of the assembly). Suitable injector shapes include wedge, parabolic, compound parabolic, etc.

The illumination assembly 100 can also include a plurality of extraction features 160. Although depicted as being positioned proximate a back surface 152 of the light guide 110, the extraction features can alternatively positioned proximate the output surface 112 of the light guide 110. Or, extraction features 160 can be positioned proximate both the output surface 112 and the back surface 116. Alternatively, the extraction features 160 can be positioned within the light guide 110.

In general, light extraction features extract light from the light guide and can be configured to enhance uniformity in light output across the surface of the light guide. Without some process of controlling light extraction from the light guide, regions of the light guide nearer to the light source can appear brighter than regions farther from the light sources. Light extraction features are arranged to provide less light extraction nearer the light sources and to provide more light extraction farther from the light sources. In implementations that use discrete light extraction features, the light extractor pattern may be non-uniform with respect to areal density, where areal density may be determined by the number of extractors within a unit area or the size of extractors within a unit area.

The extraction features 160 can include any suitable shapes and sizes for directing light from the light guide 110 through the output surface 112. For example, the extraction features 160 can be formed in a variety of sizes, geometric shapes, and surface profiles, including, for example, both protruding and recessed structures. The features 160 may be formed so that variation in at least one shape factor, such as height and/or tilt angle, controls light extraction efficiency of the features.

The size, shape, pattern, and location of the extraction features 160 along with the optical characteristics of the structured surface layer 130 can be tailored to provide a desired output light flux distribution. For example, the pattern of extraction features can be positioned such that one or more extraction features are positioned at any suitable distance from the input surface of the light guide 112, e.g., within 10 mm, 5 mm, 3 mm, 1 mm, or less. Further, the beginning of the pattern of extraction features 160 can be positioned such that one or more extraction features are positioned within any suitable distance of the plurality of light sources 120 (i.e., distance c in FIG. 1A), e.g., 10 mm, 5 mm, 3 mm, 1 mm, or less. Further, the extraction features 160 can be positioned in any suitable pattern, e.g., uniform, non-uniform, gradient etc.

Although not shown, an antireflective coating (i.e., an AR coating) can be applied to at least one of the plurality of structures 136 of the structured surface layer 130 or the input surface 114 of the light guide 110. Any suitable antireflective coating can be utilized, e.g., quarter wave films, nanoparticle coatings, or nanometer sized microreplicated features or nanostructured surface produced by reactive ion etching as described in filed U.S. Patent Application No. 61/330,592 (Attorney Docket No. 66192US002). The antireflective coating can improve coupling efficiency of light emitted by the light sources 120 into the input surface 114 of the light guide 110 by helping to prevent Fresnel reflections at the surfaces of the structures 136 and/or the input surface 114.

The illumination assembly 100 can also include an optional bezel 154 that can be positioned proximate one or more edges of the light guide 110. The bezel 154 is typically provided in displays such as LC displays to hide from the viewer the light sources 120, panel and backlight electronics, and other elements that surround the light guide 110. The bezel 154 can be any suitable size and shape. In some embodiments, a distance d from the edge of the bezel 154 closest to the output surface 112 to a primary emitting surface of one or more light sources of the plurality of light sources 120 along a normal to the input surface can be less than 20 mm, 15 mm, 10 mm, 7 mm, 5 mm, or less. The use of the structured surface layers described herein can help to reduce the distance d such that the size of the bezel is reduced, and the light sources 120 and other elements proximate the edges of the light guide 110 take up less space, thereby reducing the non-viewable area of the perimeter of the assembly 100.

As mentioned herein, the characteristics of the structures of the structured surface layer can be selected to provide the desired distribution of light that has been directed into the light guide through one or more input surfaces. In some embodiments, these characteristics can be selected to provide a light distribution that eliminates headlighting described herein by spreading the light in the plane of the light guide (e.g., the x-y plane of FIGS. 1A-B). In some embodiments, distance c is less than distance d.

Any suitable technique or techniques can be used to from the disclosed illumination assemblies. For example, in reference to FIGS. 1A-B, a light guide 110 can be formed using any suitable technique described herein. A plurality of light sources 120 can then be positioned proximate an input surface 114 of the light guide 110, where the input surface is substantially orthogonal to an output surface 112 of the light guide. The light sources 120 are operable to direct at least a portion of light into the light guide 110 through the input surface 114. A structured surface layer 130 can be attached to the input surface 114 of the light guide 110 such that the structured surface layer is between the plurality of light sources 120 and the input surface. The structured surface layer 130 can include a plurality of structures 136 on a first surface 133 of a substrate 132 that faces the light sources 120.

A desired output light flux distribution can be selected, e.g., a uniform output light flux distribution. The characteristics of the structured surface layer 130 can be selected to provide a desired light distribution of the light that is directed into the input surface 114 of the light guide 110.

Light extraction features 160 can also be formed proximate at least one of the output surface 112 or a back surface 152 of the light guide 110. The extraction features 160 can be designed to take the light distribution provided into the light guide by the light sources 120 and the structured surface layer 130 and direct the light from the light guide 110 through the output surface 112 to provide the desired output light flux distribution.

The structured surface layer 130 can be manufactured using any suitable technique. For example, the layer 130 can be formed by providing a carrier film, e.g. primed PET, having first and second major surfaces, where a prism structure or microstructure is disposed on the first major surface of the carrier film and an adhesive is disposed on the second major surface of the carrier film. The tape article prior to assembly on the light guide has a liner on the adhesive and an optional protective premask on faces of the prisms or microstructures.

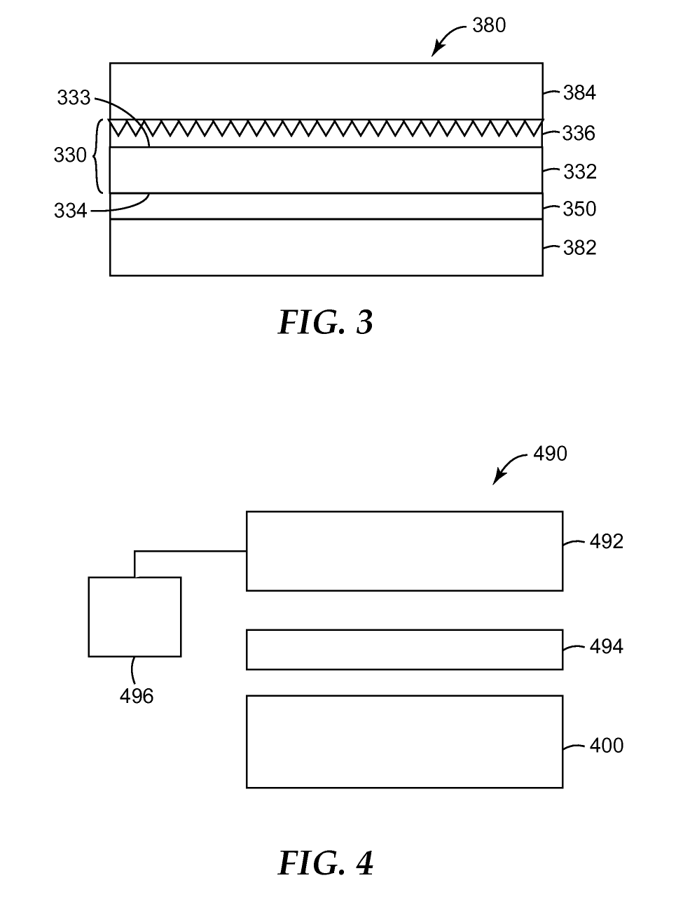

For example, FIG. 3 is a schematic cross-section view of one embodiment of a structured surface layer article 380 that includes a structured surface layer 330. The layer 330 includes a substrate 332 and a plurality of structures 336 on a first surface 333 of the substrate. The structured surface layer 330 can include any structured surface layer described herein. The article 380 also includes an adhesive layer 350 positioned on a second surface 334 of the substrate 332. A liner 382 can be provided on the adhesive layer 350 to protect the adhesive layer until the structured surface layer 330 is attached to a light guide. The article 380 also includes an optional premask 384 positioned on the structures 336 to protect them from damage prior to attachment of the layer to the light guide.

Alternatively, the structured surface layer 330 can be formed by extrusion replication. For example, an adhesive can be applied to a non-structured surface of a thermoplastic resin. The structured surface layer can include a liner on the adhesive and an optional protective premask on the structured surface of the structured surface film.

The structured surface layer 330 can also be made by a continuous cast and cure process where the prisms are cast directly on the adhesive with liner on the opposite side, thus eliminating the substrate and a significant cost.

The article 330 can be made as a roll of film having widths up to 60 inches or larger and converted to thin strips that can be positioned on the edge of a light guide. The adhesive liner 382 is removed from the adhesive layer 350, and the structured surface layer 330 is then applied to the edge of the light guide.

The structured surface layer can be converted from a large roll of film using several techniques, including slitting, rotary die cutting, and laser converting. The structured surface layer can additionally be processed in a manner to make the product in a wound roll of thin tape in a reel, can be level wound onto a wide core, or can be converted into sheets of tape on a liner. The structured surface layer tape can also be prepared as individual free pieces of film.

A roll of structured surface layer film can be prepared as a sheeted product where the film pieces are essentially long thin labels on a liner. These pieces can be prepared by kiss-cutting techniques, which are commonly known, or can be prepared by laser converting where the liner is chosen as a laser cut stop. The tape can be precut into thin strips for application to the edge of the light guide.

One alternative technique that can also be used is to convert larger pieces of the structured surface layer and assemble the layer onto a stack of polished light guides as they are in process under a typical light guide manufacturing process. The structured surface layer film can be applied to a stack of light guide plates and the film can then be converted to separate the plates in a subsequent step by processes such as slitting or laser converting. This process represents an efficient and low cost technique to apply the tape to light guides for volume manufacturing.

Returning to FIGS. 1A-B, the structured surface layer 130 can be positioned proximate the input surface 114 using any suitable technique. For example, the structured surface layer 130 can be provided as an individual tape having a removable liner on the adhesive layer 150 (e.g., article 330 of FIG. 3). The liner can be removed and the layer 130 attached to the input surface 114. A premask layer, which can be applied to the structured surface of the layer 130 during manufacturing, can be removed after the layer is attached to the light guide 110.

Alternatively, strips of the structured surface layer 130 can be wound into a tape. A portion of tape can be pulled from the roll of tape and the liner can be removed from the adhesive layer. The layer 130 can then be applied to the input surface 114 and cut to size. The roll of tape can be inserted into a tape gun to aid in application of the layer 130 to the light guide 110.

In another embodiment, a two-part kit that includes a transfer adhesive gun and a roll of structured surface layer tape can be provided. The adhesive gun can be used to first apply adhesive to the input surface 114, then the layer 130 can be applied to the adhesive and cut to size.

The structured surface layer 130 can provide a desired light distribution of the light that is directed from the plurality of light sources 120 into the light guide 110 through the input surface 114. For example, ray 170 is emitted by light source 120 and is incident upon the structured surface layer 130. The layer 130 redirects (e.g., by refraction or diffraction) ray 170 into the light guide 110 such that it forms an angle α with a normal 172 to the input surface 114 in the plane of the light guide (i.e., x-y plane). This ray 170 is injected into the light guide 110 at an angle greater than the TIR angle θ of the light guide 110. As can be seen in FIG. 1B, the light from the light sources 120, therefore, can be directed into the light guide 110 such that the light is spread out within the plane of the light guide, thereby reducing the headlighting effect.

This is also shown schematically in FIG. 1B. The cone angle for the light entering the light guide 112 from one of the light sources 120 is shown as the combination of areas 176 and 178. Area 178 is the cone of light that represent the cone angle that would be defined by the light guide refractive index, assuming no structured surface layer is positioned between the light sources and the input surface of the light guide. The areas 176 on either side of the area 178 define the light that is directed by the structured surface layer 130 into a cone angle that is larger than the TIR cone angle for the light guide 112. Ideally, the structured surface layer 130 provides enough light at angles in excess of the TIR cone angle to fill-in the area e between the emitting surfaces of two adjacent light sources 120.

Since a percentage of the light entering the light guide 112 is outside of the TIR cone angle of the light guide, e.g., 10%, there will be a portion of light that reaches the adjacent edges 118 of the light guide 112 that is not reflected back into the light guide by TIR. Because of this, in some embodiments it is useful to have a side reflector 140 proximate to or attached to one or more edges 118 of the light guide. In some embodiments, the reflector 140 can be separated from the edge 118 of the light guide 112 by an air gap. In this case, the reflector may be free floating between a backlight frame and the edge 118 of the light guide 112, or the reflector may be adhered to the backlight frame for support. In some embodiments the reflectors 140 can be attached to the edges 118 of the light guide 112, which is further described herein.

Regardless of whether the reflector 140 is attached to or separated from the light guide edge 118, the side reflector 140 should be positioned and have properties such that when light is incident upon the reflector that the reflector returns at least 90% of the light, and the majority of the light returned is within the out of plane TIR zone. It may be preferred that the reflector 140 returns light into the light guide 112 that is outside of the in-plane TIR zone that would otherwise escape the light guide without significantly diverting light in the thickness direction (i.e., the z direction), such that it is outside of the out-of-plane TIR zone. Because it is desirable to keep the light that is reflected by the side reflector 140 within the out-of plane TIR zone, it may be preferred that the side reflector 140 be specular or semispecular as is further described herein.

The goal of removing LEDs and increasing the spacing between each LED to lower cost requires careful consideration of all of the parameters such that the performance of the illumination assembly is not adversely affected. FIGS. 1A-B show several relationships that can affect the performance of the assembly, specifically whether the assembly will provide acceptable uniformity at the edge of the viewable area of the output surface 112 of the assembly. For example, distance a is the light source 120 center-to-center spacing; b is the distance from the emitting surfaces of the light sources 120 to the input surface 114 of the light guide 112; b′ is the distance between the emitting surfaces of the light sources and the structures 136 of the structured surface layer 130; c is the distance between the emitting surfaces of the light sources 120 and the extraction pattern 160; d the distance between the emitting surfaces of the light sources 120 and the end of the bezel 154 that is closest to the center of the output surface 112; and e the distance between the primary emitting surfaces of the light sources 120. These distances can include any suitable dimensions that provide the desired uniformity of light that is directed through the output surface 112 of the light guide 112. For example, each of these distances can be less than 15 mm, 10 mm, 5 mm, 1 mm, or smaller.

The illumination assemblies of the present disclosure can be used to provide illumination light for any suitable application. For example, the described illumination assemblies can be used as backlights for LC displays and active or passive signs. The described assemblies can also be used in luminaires or light fixtures for architectural lighting or general illumination, task lights, etc.

For example, a schematic cross-sectional view of one embodiment of a direct-lit display system 490 is illustrated in FIG. 4. Such a display system 490 may be used, for example, in an LCD monitor, LCD tablet device or LCD-TV. The display system 490 includes a display panel 492 and an illumination assembly 400 positioned to provide light to the panel 492. The display panel 492 can include any suitable type of display. The display panel 492 can include an LC panel. The LC panel 492 typically includes a layer of LC disposed between panel plates. The plates are often formed of glass and can include electrode structures and alignment layers on their inner surfaces for controlling the orientation of the liquid crystals in the LC layer. These electrode structures are commonly arranged so as to define LC panel pixels, i.e., areas of the LC layer where the orientation of the liquid crystals can be controlled independently of adjacent areas. A color filter may also be included with one or more of the plates for imposing color on the image displayed by the LC panel 492.

The LC panel 492 is typically positioned between an upper absorbing polarizer and a lower absorbing polarizer. The upper and lower absorbing polarizers are located outside the LC panel 492. The absorbing polarizers and the LC panel 492 in combination control the transmission of light from the backlight 400 through the display system 490 to the viewer. For example, the absorbing polarizers may be arranged with their transmission axes perpendicular to each other. In an unactivated state, a pixel of the LC layer may not change the polarization of light passing therethrough. Accordingly, light that passes through the lower absorbing polarizer is absorbed by the upper absorbing polarizer. When the pixel is activated, the polarization of the light passing therethrough is rotated so that at least some of the light that is transmitted through the lower absorbing polarizer is also transmitted through the upper absorbing polarizer. Selective activation of the different pixels of the LC layer, for example, by a controller 496, results in the light passing out of the display system 490 at certain desired locations, thus forming an image seen by the viewer. The controller 496 may include, for example, a computer or a television controller that receives and displays television images.

One or more optional layers may be provided proximate the upper absorbing polarizer, for example, to provide mechanical and/or environmental protection to the display surface. In one exemplary embodiment, the layer may include a hardcoat over the upper absorbing polarizer.

It will be appreciated that some types of LC displays may operate in a manner different from that described above. For example, the absorbing polarizers may be aligned parallel and the LC panel may rotate the polarization of the light when in an unactivated state. Regardless, the basic structure of such displays remains similar to that described herein.

The system 490 includes a backlight 400 and optionally one or more light management films 494 positioned between the backlight 400 and the LC panel 492. The backlight 400 can include any illumination assembly described herein, e.g., illumination assembly 100 of FIGS. 1A-B.

An arrangement of light management films 494, which may also be referred to as a light management unit, is positioned between the backlight 400 and the LC panel 492. The light management films 494 affect the illumination light propagating from the backlight 400. For example, the arrangement of light management films 494 may include a diffuser. The diffuser is used to diffuse the light received from the backlight 490.

The diffuser layer may be any suitable diffuser film or plate. For example, the diffuser layer can include any suitable diffusing material or materials. In some embodiments, the diffuser layer may include a polymeric matrix of polymethyl methacrylate (PMMA) with a variety of dispersed phases that include glass, polystyrene beads, and CaCO3 particles. Exemplary diffusers can include 3M™ Scotchcal™ Diffuser Film, types 3635-30, 3635-70, and 3635-100, available from 3M Company, St. Paul, Minn.

The optional light management unit 494 may also include a reflective polarizer. Any suitable type of reflective polarizer may be used for the reflective polarizer, e.g., multilayer optical film (MOF) reflective polarizers; diffusely reflective polarizing film (DRPF), such as continuous/disperse phase polarizers including fiber polarizers, wire grid reflective polarizers, or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in co-owned U.S. Pat. No. 5,882,774 (Jonza et al.), and the reflective polarizers described in PCT Patent Publication No. WO 2008/144656 (Weber et al.). Commercially available examples of MOF reflective polarizers include DBEF-D200 and DBEF-D440 multilayer reflective polarizers that include diffusive surfaces, available from 3M Company.

Examples of DRPF useful in connection with the present disclosure include continuous/disperse phase reflective polarizers as described, e.g., in co-owned U.S. Pat. No. 5,825,543 (Ouderkirk et al.), and diffusely reflecting multilayer polarizers as described, e.g., in co-owned U.S. Pat. No. 5,867,316 (Carlson et al.). Other suitable types of DRPF are described in U.S. Pat. No. 5,751,388 (Larson).

Some examples of wire grid polarizers useful in connection with the present disclosure include those described, e.g., in U.S. Pat. No. 6,122,103 (Perkins et al.). Wire grid polarizers are commercially available, inter alia, from Moxtek Inc., Orem, Utah.

Some examples of cholesteric polarizers useful in connection with the present disclosure include those described, e.g., in U.S. Pat. No. 5,793,456 (Broer et al.), and U.S. Patent Publication No. 2002/0159019 (Pokorny et al.). Cholesteric polarizers are often provided along with a quarter wave retarding layer on the output side so that the light transmitted through the cholesteric polarizer is converted to linearly polarized light.

In some embodiments, a polarization control layer may be provided between the diffuser plate and the reflective polarizer. Examples of polarization control layers include a quarter wave retarding layer and a polarization rotating layer such as a liquid crystal polarization rotating layer. The polarization control layer may be used to change the polarization of light that is reflected from the reflective polarizer so that an increased fraction of the recycled light is transmitted through the reflective polarizer.

The optional arrangement of light management films 494 may also include one or more brightness enhancing layers. A brightness enhancing layer can redirect off-axis light in a direction closer to the axis of the display. This increases the amount of light propagating on-axis through the LC layer, thus increasing the brightness of the image seen by the viewer. One example of a brightness enhancing layer is a prismatic brightness enhancing layer, which has a number of prismatic ridges that redirect the illumination light through refraction and reflection. Examples of prismatic brightness enhancing layers that may be used in the display system 490 include the BEF II and BEF III family of prismatic films available from 3M Company, including BEF II 90/24, BEF II 90/50, BEF IIIM 90/50, and BEF IIIT. Brightness enhancement may also be provided by some of the embodiments of front reflectors as is further described herein.

### EXAMPLES

### Comparative Example 1

### Reference Illumination Assembly

A reference illumination assembly was modeled using standard modeling techniques. The assembly included a light guide having an input surface, and light sources positioned to direct light into the light guide (e.g., illumination assembly 100 of FIGS. 1A-B). The light guide had an index of refraction of 1.51. For this and other modeled examples, the coupling efficiency was defined as the percentage of light rays emitted by the light source that reached the edge of the light guide furthest from the input surface. To characterize the angular spread of coupled rays in the plane of the light guide, a detector was placed in the model at a distance of 1.5 mm away from the input surface. The detector spanned the width of the light guide (10 mm). This detector measured the brightness profile across the light guide in a plane parallel to the input surface. Uniformity was defined as L_{Min}/L_{Max}×100%, where L is the luminance FIG. 6 is a graph of Luminance (cd/m²) versus position (mm) in the light guide in the plane parallel to the input surface along the y-axis (see FIG. 1B).

This reference assembly did not include a structured surface layer. The coupling efficiency was equal to 93.2%, and uniformity was equal to 34%.

### Example 1

### Illumination Assembly Having a Structured Surface Layer with Extended Prismatic Structures

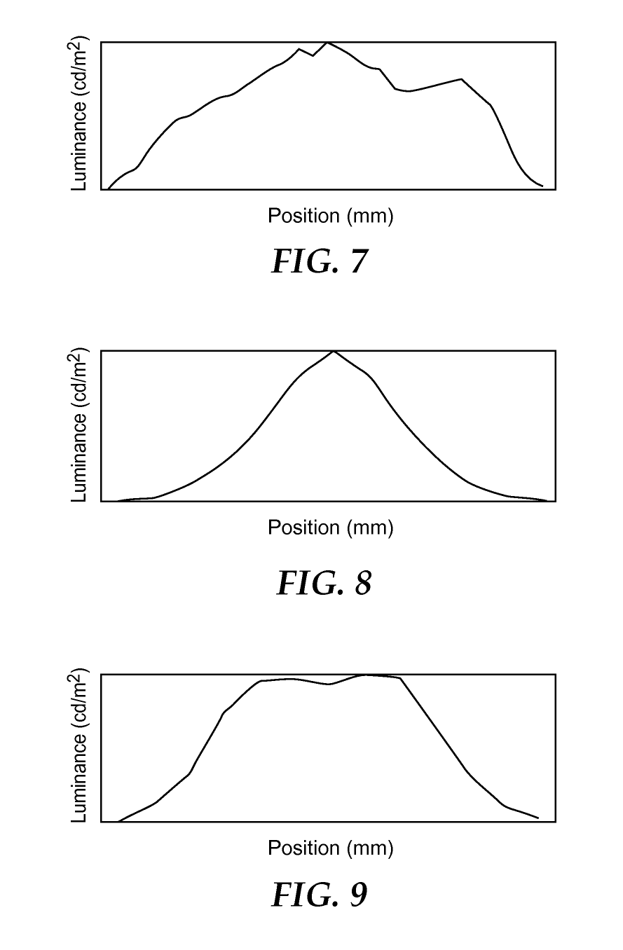

The reference illumination assembly of Comparative Example 1 was again modeled with a structured surface layer positioned on the input surface of the light guide. The structured surface layer included a plurality of structures that included linear prisms oriented such that the prism direction was orthogonal to the plane of the light guide. The prisms had a 90 degree apex angle. The prisms faced away from the light guide with prism tips facing the LED light sources. The surface of the prisms also included an AR coating. FIG. 7 is a graph of Luminance (cd/m²) versus position (mm) in the light guide in the plane parallel to the input surface along the y-axis.

The coupling efficiency of the light emitted from the LED light sources increased to 97% from the 93.2% coupling efficiency of Comparative Example 1. The structured surface layer helped to minimize the number of light rays that were incident at grazing angles to the input surface. Uniformity improved to 69% from the 34% uniformity of Comparative Example 1.

### Comparative Example 2

### Reference Illumination Assembly

A simulation of brightness uniformity of a reference illumination assembly that included a standard PMMA light guide of index 1.49 was performed using standard modeling techniques. An LED was positioned 1 mm from an input surface of the light guide. The size of the LED emitting surface was 1 mm×2 mm, the LED spacing was equal to 10 mm, and the light guide's thickness was 4 mm. FIG. 8 is a graph of luminance in cd/m² versus position in the light guide in a direction parallel to the input surface (e.g., the y-axis in FIG. 1B) measured in a plane parallel to the input surface.

The brightness uniformity was equal to 4.1%, and the coupling efficiency was equal to 94.5%.

### Example 2

### Illumination Assembly Including Structured Surface Layer

A simulation of the illumination assembly of Comparative Example 2 with a structured surface layer positioned between the LED light source and the input surface of the light guide was performed using standard modeling techniques. The structured surface layer was index-matched to the light guide (n=1.49). A planar side of the structured surface layer was optically coupled to the light guide. The brightness profile measured in a plane parallel to the input surface within the light guide is shown in FIG. 9.

In the plane of the light guide, the refraction-induced cone of light has been substantially broadened, resulting in a significantly greater overlap at the detector with rays from neighboring LEDs. The brightness uniformity for this modeled example increased to 17.3% from the 4.1% of Comparative Example 2, while coupling efficiency was nearly identical at 95.5%.

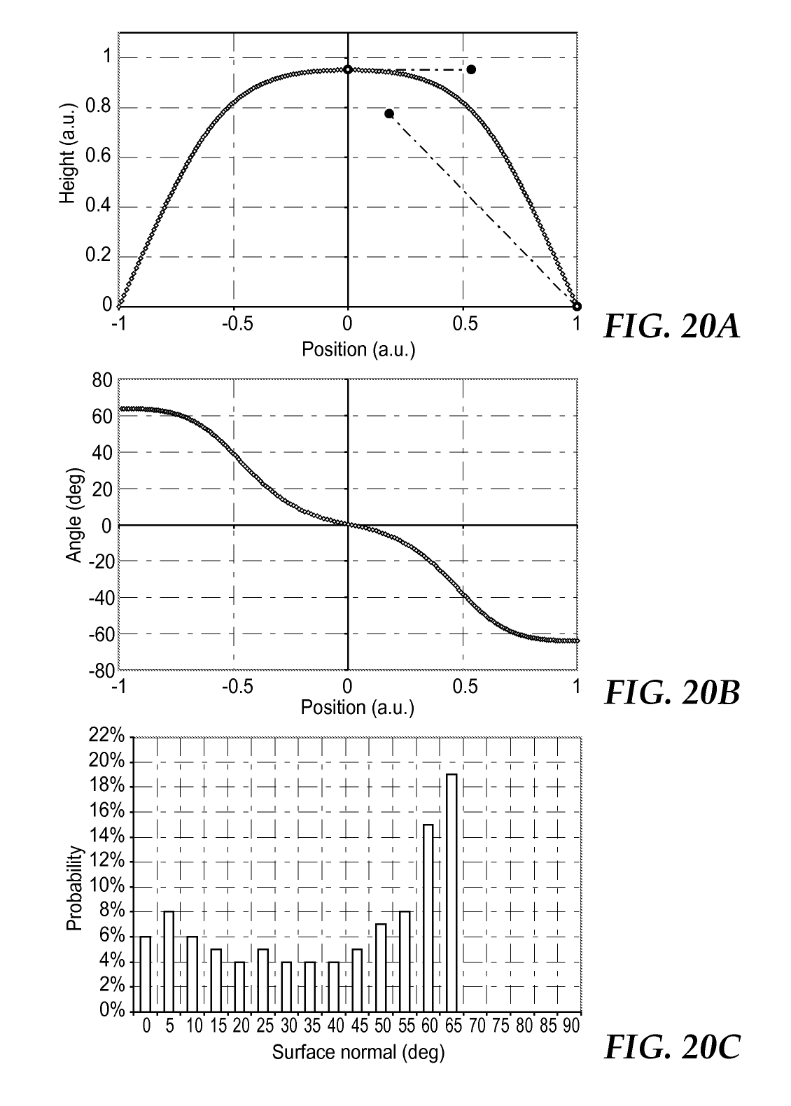

The shapes of the plurality of structures of the structured surface layer of Example 2 is shown in FIG. 20A as a Bezier curve. The structures were aspheric prisms that were aligned perpendicularly to the plane of the light guide (i.e., along the z-axis). The structured surface layer was translationally invariant and did not require registration of the layer with the light sources. The distribution of surface normals of the shape of FIG. 20A is shown in FIG. 20B. The distribution includes all angles between +/−65 degrees to a normal to the structure, which can provide a broad spreading of light in the plane of the light guide for light that enters the light guide.

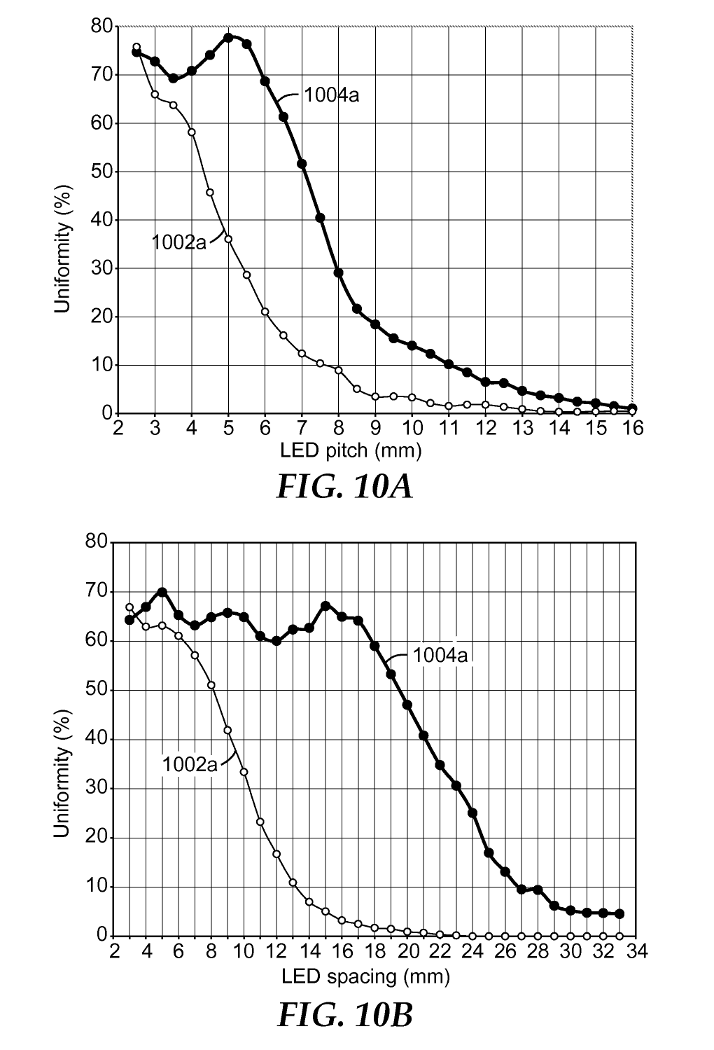

The additional light spreading produced by the structured surface layer can be used to increase LED spacing in a light guide design. Depending on the application, a desired uniformity threshold can be determined for a given distance between the light sources and a given distance between the light sources and the input surface of the light guide. For example, FIG. 10A is a graph of uniformity versus light source pitch for an illumination assembly that was modeled using standard modeling techniques. The illumination assembly include a plurality of light sources (e.g., light sources 120 of FIGS. 1A-B) that were positioned at a distance of 1 mm from an input surface (e.g., input surface 114) of a light guide (e.g., light guide 110). The assembly was modeled for various light source pitches. Curve 1002a represents an illumination assembly that does not include a structured surface layer, and curve 1004a represents an illumination assembly that includes a structured surface layer as described herein (e.g., structured surface layer 130).

Further, FIG. 10B is a graph of uniformity versus light source pitch for an illumination assembly that does not include a structured surface layer (i.e., curve 1002b) and that does include a structured surface layer (i.e., curve 1004b). Various light source pitches were modeled. In this model, the light sources were positioned a distance of 5 mm from the input surface of the light guide.

As can be seen in FIG. 10B, for a desired output light flux distribution, the structured surface layer can enable more than a doubling of the LED spacing, therefore allowing for freedom in system design. For example, use of the disclosed structured surface layers can enable the use of lower-cost LEDs, e.g., large-die LEDs. This design freedom can also help improve system efficacy by allowing more space between LEDs for improved thermal management. Finally the light spreading that is enabled by the described structured surface layers can help to solve the problem of brightness uniformity in large aspect ratio (thin) systems by enabling a two-side illuminated architecture with the same number of LEDs as a single-side illuminated architecture, thus reducing the effective aspect ratio of the assembly.

### Example 3

### Microreplication of a Linear Aspheric Prism Structured Surface Layer

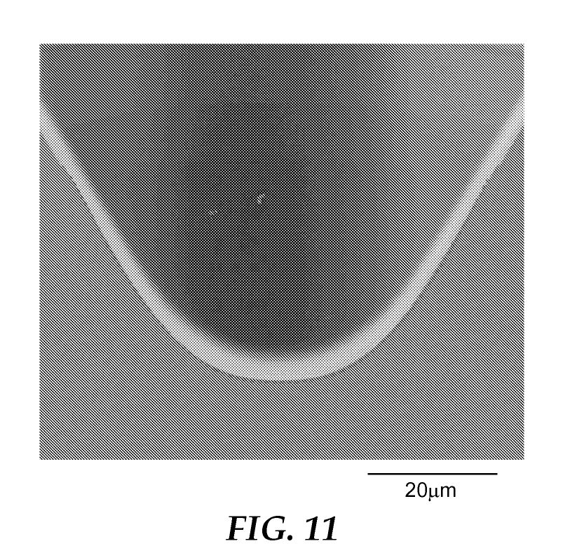

A microreplication tool was used to make a structured surface layer having the linear prism structures as described in reference to FIGS. 20A-B. The tool used for making the layer was a modified diamond turned metallic cylindrical tool pattern that was cut into a copper surface of the tool using a precision diamond turning machine that included the diamond shown in FIG. 11. The diamond was made by taking a rough cut diamond and shaping it using Focused Ion Beam milling such that the shape of the diamond matched the structure profile shown in FIG. 20A (represented by the dotted line in FIG. 11). The resulting copper cylinder with precision-cut features was nickel plated and treated for release using processes as described in U.S. Pat. No. 5,183,597 (Lu).

The structured surface layer was made using a series of acrylate resins including acrylate monomers and a photoinitiator that was cast onto a primed PET support film (2 mil in thickness) and was then cured against the precision cylindrical tool using ultraviolet light. The first resin was a 75/25 mixture by weight of CN120 (an epoxy acrylate oligomer available from Sartomer Company, Exton, Pa.) and Phenoxyethyl acrylate (available from Sartomer under the name SR3339) with a photoinitiator package composed of 0.25% by weight of Darocur 1173 and 0.1% by weight Darocur TPO (both available from Ciba Specialty Chemicals Inc.). This first resin when cured provides a solid polymeric material with a refractive index of 1.57. The second resin was a phococurable acrylate formulation prepared as described in PCT Patent Publication No. WO 2010/074862 in Example 2. The cured second resin when cured provides a solid polymeric material with a refractive index of 1.65. Cast and cure techniques for preparing microstructure-bearing articles are described in U.S. Pat. No. 5,183,597 (Lu) and U.S. Pat. No. 5,175,030 (Lu et al.).

A film microreplication apparatus was employed to make the linear asphere structures on a continuous film substrate. The apparatus included a series of needle die and gear pumps for applying the coating solution; the cylindrical microreplication tool; a rubber nip roll against the tool; a Fusion UV curing source operating a 60% of maximum power arranged adjacent the surface of the microreplication tool; and a web handling system to supply, tension, and take up the continuous film. The apparatus was configured to control a number of coating parameters, including tool temperature, tool rotation, web speed, rubber nip roll/tool pressure, coating solution flow rate, and UV irradiance. The structured surface layer was made using a series of acrylate resins including acrylate monomers and a photoinitiator. The photocurable acrylate resin was cast onto a primed PET support film (2 mil thicknesses) and was then cured between the PET support film the precision cylindrical tool using ultraviolet light. For the first of the two resins, the one having a cured refractive index of 1.57, the cast and cure process was run using the following conditions: line speed of 70 ft/min.; Tool temperature of 135 degrees Fahrenheit; Nip Pressure ranging from 15 to 50 psi; and Fusion UV curing light source running at 60% of maximum power. For the second of the two resins, i.e., the resin having a cured refractive index of 1.65, the cast and cure process was run using the following conditions: line speed of 50 ft/min.; tool temperature of 125 degrees Fahrenheit; nip pressure of 15 psi; and Fusion UV curing light source running at 60% of maximum power.

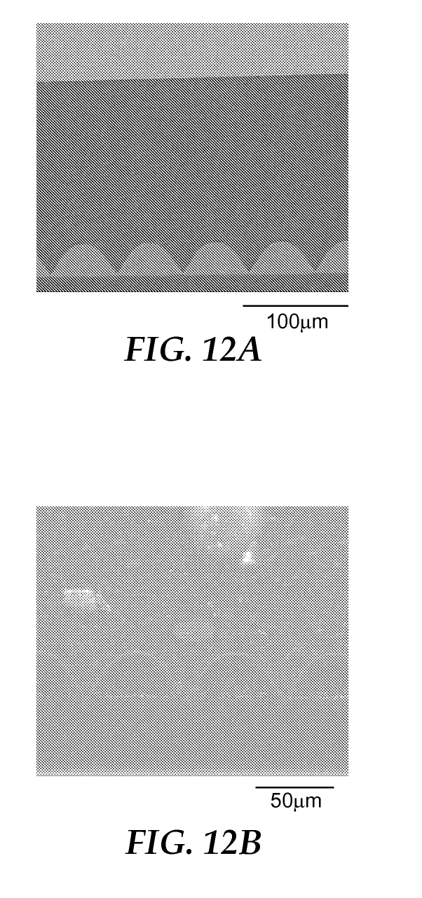

To characterize the resulting microreplicated films, pieces of the two films with different index prism structures were potted in Scotchcast 5 (available from 3M Company), and a cross-section was taken such that the cross section was orthogonal to the direction of the linear asphere prisms. FIG. 12A shows the cross section for the microreplicated layer made with an acrylate resin with a cured refractive index of 1.57, and FIG. 12B shows the cross section of the zirconia filled cured acrylate resin with a refractive index of 1.65.

Both of the microreplicated films, n=1.57 linear aspheres and n=1.65 linear aspheres, were laminated with an optically clear pressure sensitive adhesive 8172-CL (a 2 mil pressure sensitive adhesive between two liners (available from 3M Company)). The laminated film was then converted by cutting 3 mm wide strips of the film orthogonal to the linear asphere direction, such that the structured surface layer included 3 mm long repeating linear asphere microstructures, and the length of the tape was 54 inches long.

To evaluate the performance of the structured surface layer, a display test bed was chosen. The display was a Lenovo ThinkVision L2251xwD 22″ diagonal monitor having a 16:9 aspect ratio. The monitor included a backlight cavity having a white reflector, an acrylic light guide sitting in the backlight cavity with the white reflector behind it, the acrylic light guide having a white gradient extraction dot pattern printed on its surface, a row of LEDs illuminating the waveguide from the bottom edge of the light guide/display, a standard stack of brightness enhancing films including a diffuser film, a microlens film and DBEF D-280, an LCD panel, and a bezel over the LCD panel.

The LED light bar consisted of 54 LEDs driven as 6 separate strings with 9 LEDs powered in series on each string. The LED strings were arranged on the light bar such that they were interlaced, that is, every sixth LED was of the same string (the strings were organized in the following repeating manner s1-s2-s3-s4-s5-s6-s1-s2-s3-s4-s5-s6 and so on). This arrangement allowed for simple rewiring to allow for varied LED spacing (center-to-center pitch) in the backlight by controlling each LED string separately. The wiring modifications allowed for the following configurations; all LEDs on (9 mm LED center-to-center spacing), every other LED on (18 mm center to center spacing), every third LED on (27 mm center-to-center spacing), and every sixth LED on (54 mm center to center spacing). To double the LED spacing, every other LED string can be activated (s1+s3+s5, or s2+s4+s6). To triple the LED spacing, every third LED string can be activated (s1+s4, s2+s5, or s3+s6). And finally, to get 6× spacing, only one of the LED strings can be activated.

The display had the following critical dimensions: native LED center-to-center spacing of 9 mm (all LEDs on), a distance from the surface of the LED to the input surface of light guide of less than 0.25 mm, a distance from the LED to the start of the extraction pattern of about 2 mm, and a distance from the surface of the LED to the edge of the bezel in the fully-assembled display of about 5 mm. The LEDs are phosphor converted white LEDs with two die in a single package and have an emitting surface of about 2 mm×4.5 mm. Given the size of the LEDs the spacing between emitting areas of adjacent LEDs (distance e in FIG. 1B) would correspond to 5 mm, 14 mm, 23 mm, and 50 mm respectively for the corresponding LED center to center spacing of 9 mm, 18 mm, 27 mm, and 54 mm. One feature of note is that the light guide extraction pattern was of varying size or density at the edge of the input surface of the light guide. This feature was designed to provide better uniformity for the original 9 mm LED pitch configuration.

To evaluate the effectiveness of the structured surface layer, strips of the layer or tape were applied to the input surface of the light guide by a hand lamination process. The optically clear adhesive when applied wet-out and conformed to the surface roughness of the input surface of the light guide such that the microstructured layer was optically coupled to the input surface without any air being trapped between the adhesive and the input surface.

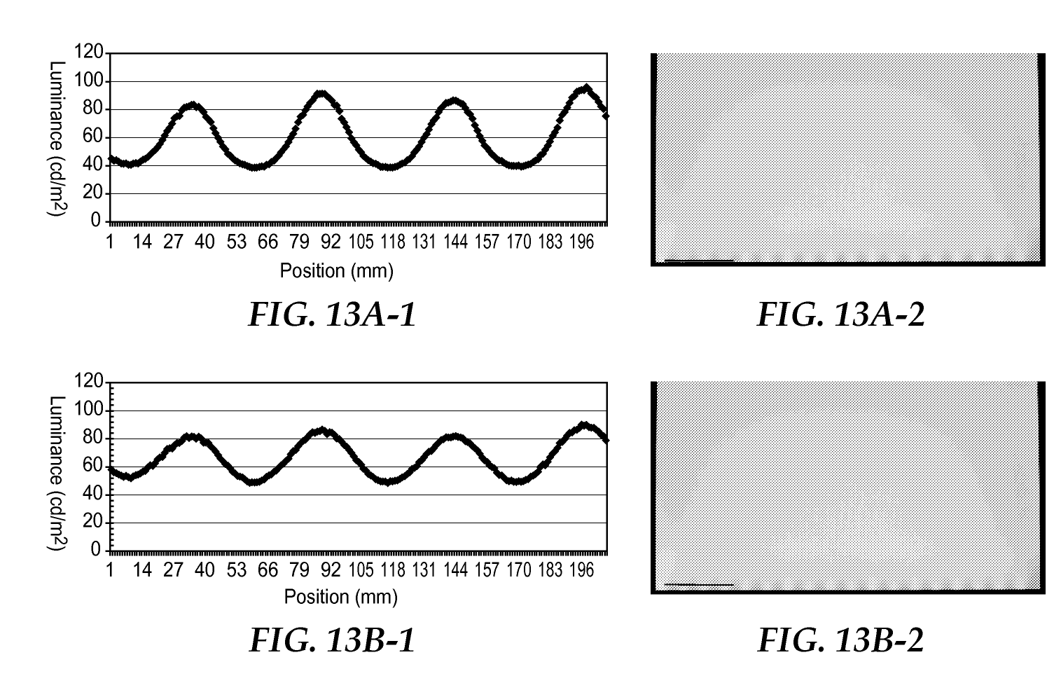

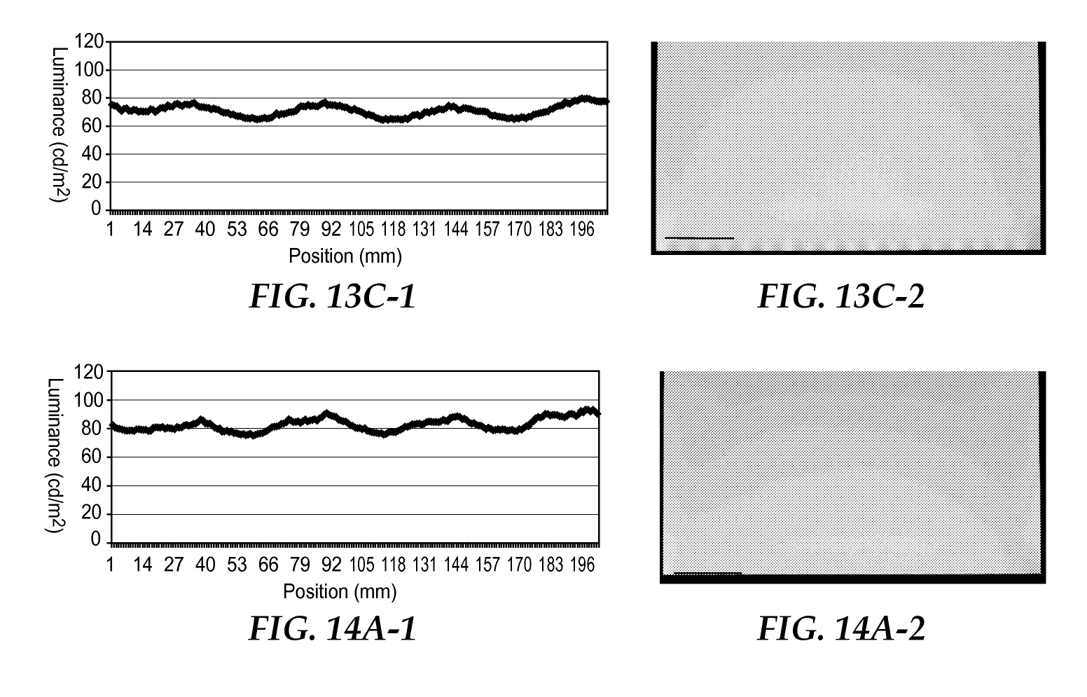

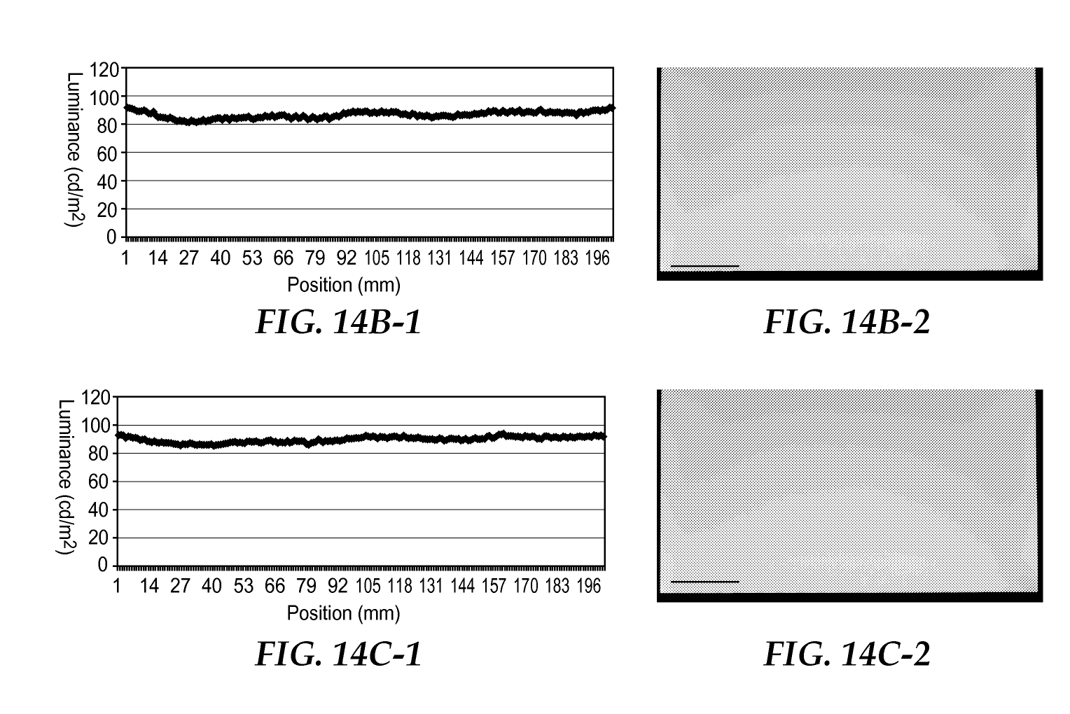

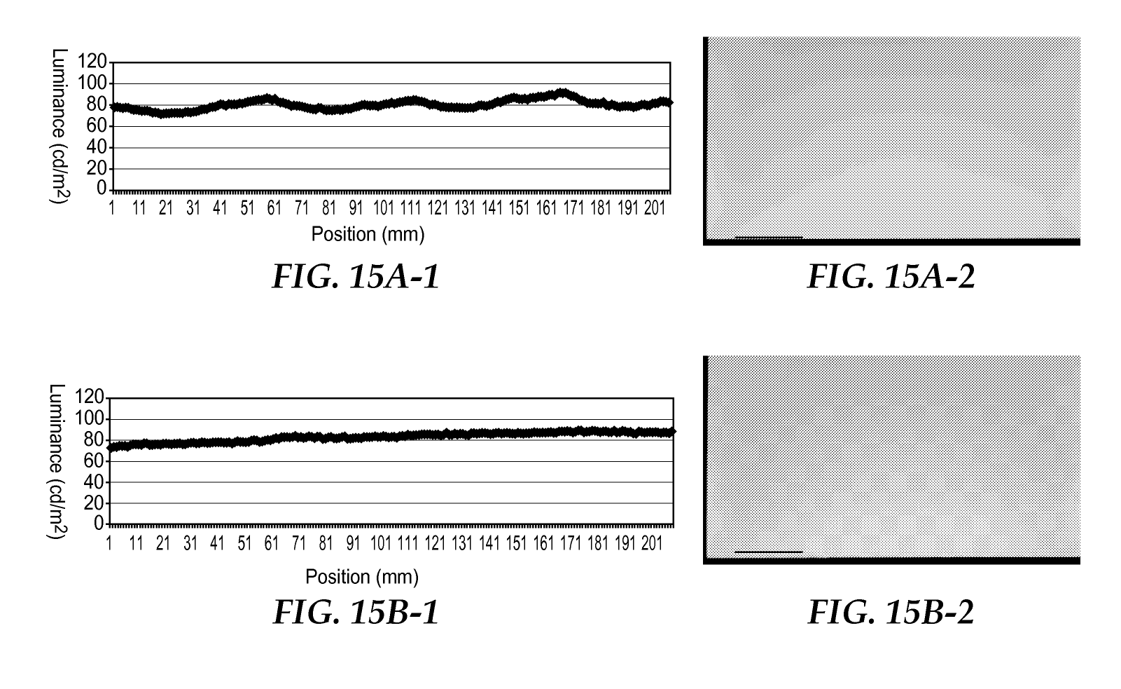

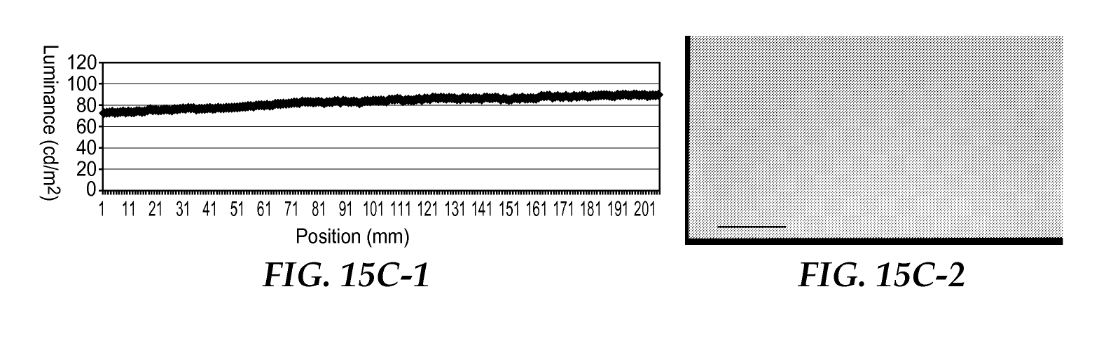

FIGS. 13A-1, B-1, and C-1 show luminance intensity line scans from a prometric image for the display with no structured surface layer and a 27 mm center-to-center LED spacing. FIGS. 13A-2, B-2, and C-2 show the prometric images of the illumination assembly, where the black line indicates the locating of the line scans shown in FIGS. 13A-1, B-1, and C-1. FIGS. 14A-C show luminance intensity line scans and the illumination assembly images from a prometric image for the display with the structured surface layer film having an index of refraction of 1.57 and a 27 mm center-to-center LED spacing for the assembly. FIGS. 15A-C show luminance intensity line scans and prometric images of the illumination assembly for the display with structured surface layer having an index of refraction of 1.65, and a 27 mm center-to-center LED spacing for the assembly. For each parametric image the line scans all covered the same range of 3 LEDs at the lower left corner of the display. Line scans for each case were taken at a distance of 5 pixels or 2.4 mm from the bezel, 16 pixels or 7.6 mm from the bezel, and 30 pixels or 14.3 mm from the bezel. The distance of each line scan from the edge of the light guide was 7.4 mm, 12.6 mm and 19.3 mm.

The summary of the uniformity data for each case is summarized in Table 1 and confirms that the assemblies that include a structured surface layer are more uniform at a 27 mm center-to-center spacing (23 mm space between emitting areas of adjacent LEDs) than the assembly that does not include a structured surface layer.

TABLE 1
Measured uniformity as function of distance from display bezel

| | Line scan distance from bezel | | |
|---|---|---|---|
| | 2.4 mm | 7.6 mm | 14.3 mm |
| No Tape | 45% | 60% | 88% |
| Tape, n = 1.545 | 84% | 98% | 98% |
| Tape, n = 1.62 | 88% | 98% | 98% |

### Example 4

### Distance of Light Sources from Input Surface of Light Guide

The following examples were performed using ASAP, a commercially available ray tracing program from Breault Research Organization, Inc. (Tucson, Ark.). The following assumption were used for these examples: the light guide index was set to 1.51, the linear aspheric prismatic shape from FIGS. 20A-B used, the refractive index of the structures of the structured surface layer was set to 1.62, the LED emitting surface was 2 mm×3.5 mm, the light guide thickness was 3 mm, and a detector was placed 5 mm in from the input surface of the light guide to measure uniformity.

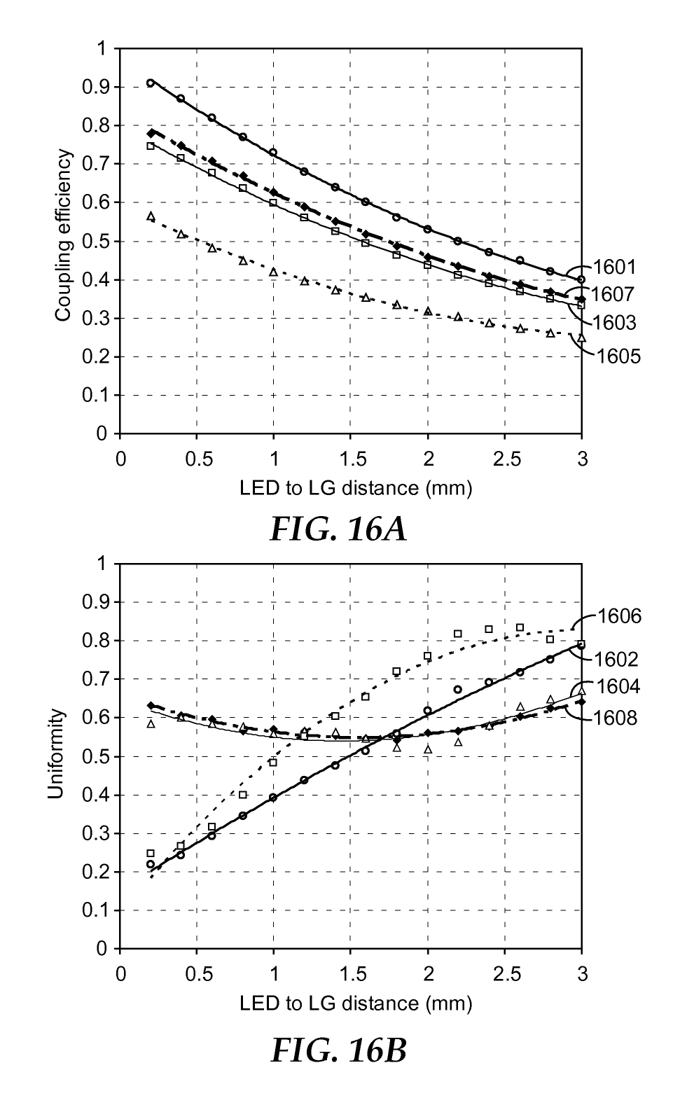

The first parameter to consider is the distance between the light sources and the light guide. This distance in combination with the structured surface can affect performance of the illumination assembly. FIG. 16A-B shows data for coupling efficiency and uniformity as a function of the distance of the LED to the input surface of the light guide. For this model, the light sources were positioned on the input surface of the light guide, and the orthogonal edges of the light guide were made to be absorbing. Curves 1601 and 1602 are for an illumination assembly that does not include a structured surface layer; curves 1603 and 1604 represent an illumination assembly that includes a structured surface layer attached to an input surface of the light guide; curves 1605 and 1606 represent an illumination assembly with a structured surface layer that is spaced apart from the input surface of the light guide; and curves 1607 and 1608 represent an illumination assembly that includes an attached structured surface layer having an AR coating that is formed on the structures. As seen in FIGS. 16A-B, there is a significant loss of light for the cases where the structured surface layer was used. This drop in system efficiency is a result of the structured surface layer directing a significant portion of light outside the in-plane TIR zone, which then escapes from the light guide on an adjacent orthogonal edge of the guide. Further, increasing the distance between the LED and the input surface of the light guide allows more distance for light mixing, which improves uniformity, but also decreases the amount of light that can be coupled into the light guide because more rays will be absorbed before reaching the light guide.

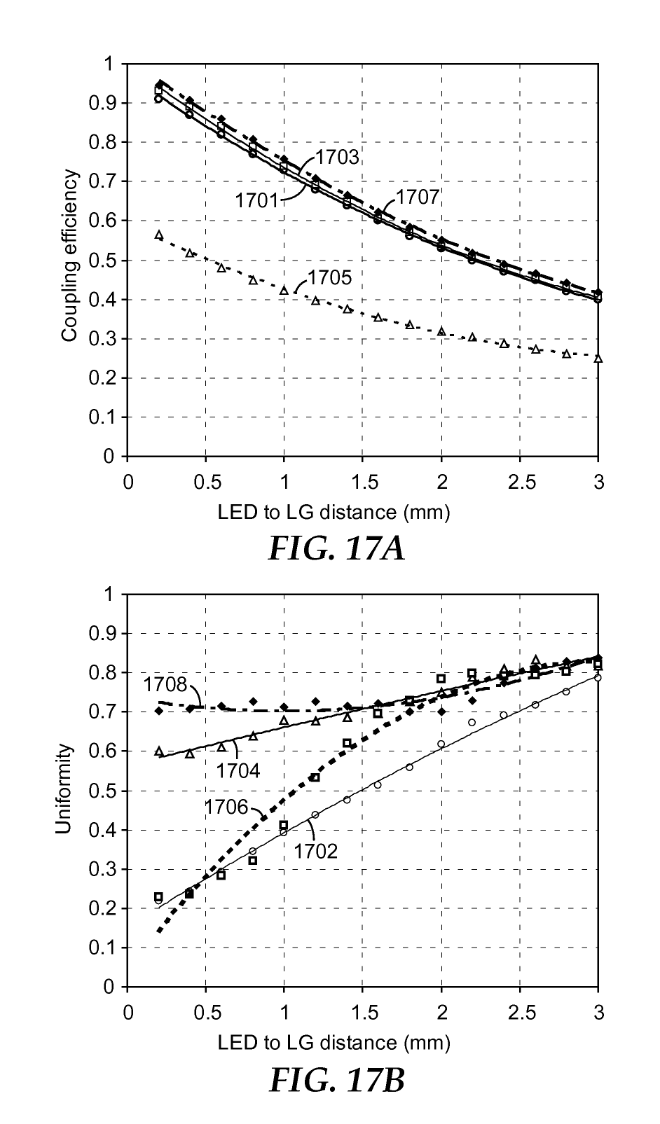

FIGS. 17A-B show the same experiment, except that in this case the orthogonal edge of the light guide is highly reflective (e.g., has an Enhanced Specular Reflector attached to this side). The use of a reflector on the adjacent and orthogonal light guide edge can increase the efficiency over the case that does not include a structured surface layer. While the structured surface layer still sends light outside of the in-plane TIR zone, the side reflectors return it to the assembly, thereby maintaining system efficiency. For comparison, a detached structured surface layer can improve uniformity in the light guide, but can decrease the assembly's efficiency.

### Example 5

### Light Guide Refractive Index

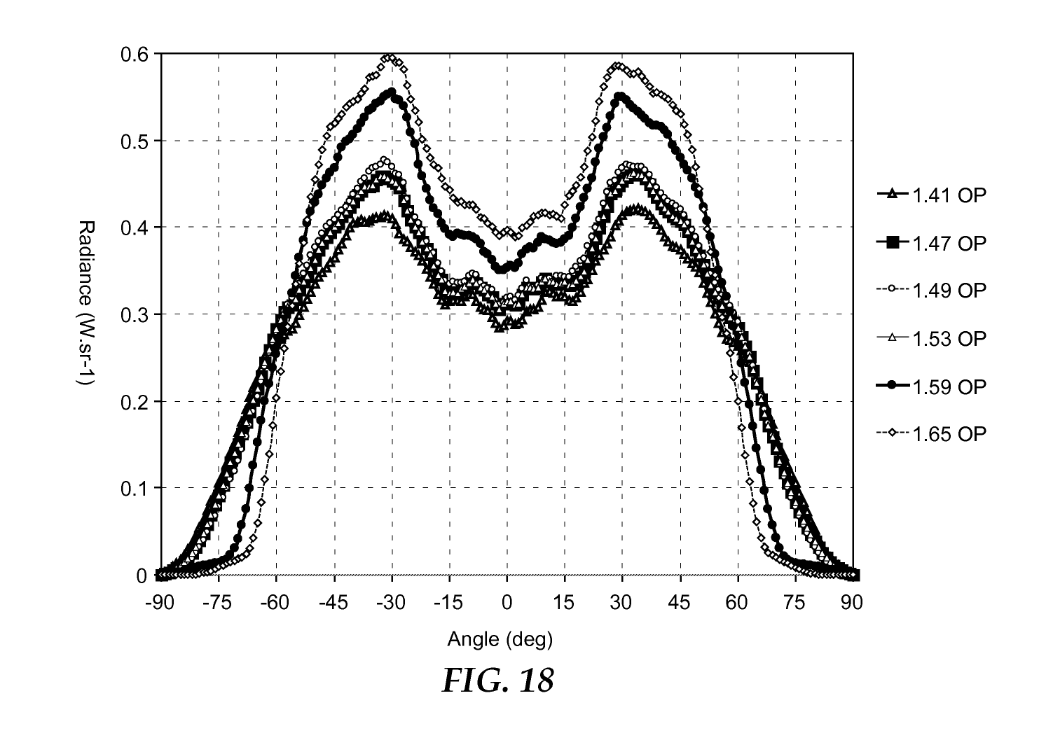

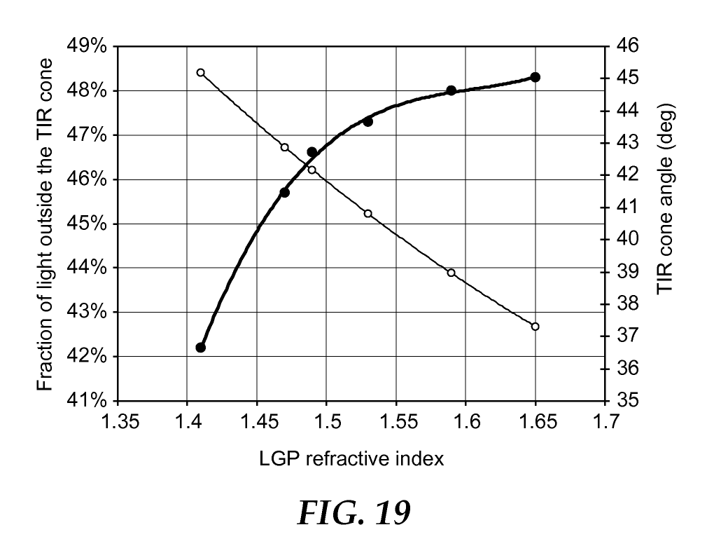

FIG. 18 shows the relationship of the refractive index of the light guide to the fraction of light that enters the light guide outside of the TIR cone angle. For all of these cases, the linear aspheric prismatic structured surface layer had an index of 1.62. As seen in the graph, as the index of the light guide increases, the TIR cone angle decreases, and the fraction of light that enters the light guide outside of the TIR cone angle increases. This is also shown graphically in FIG. 19, where 40-50% of the light in the guide is outside of the TIR cone angle in the plane of the guide. The presence of side reflectors on the orthogonal edges return a significant amount of light to the system.

### Example 6

### Optimized Shapes of Structures of the Structured Surface Layer

Various shapes of structures of the structured surface layer were modeled using a cubic Bezier function and optimized for four different refractive indices: n=1.49, n=1.545, n=1.62 and n=1.65. The equation for the cubic Bezier curve is derived as follows: given two ends points (x₀, y₀) and (x₃, y₃) and two control points (x₁, y₁) and (x₂, y₂), then the Bezier curve that joins the two end points is given by:

x(t)=aₓt³+bₓt²+cₓt+x₀, y(t)=a_{y}t³+b_{y}t²+c_{y}t+y₀ for tε[0 1],

where:
cₓ=3(x₁−x₀)
bₓ=3(x₂−x₁)−cₓ
aₓ=x₃−x₀−cₓ−bₓ
c_{y}=3(y₁−y₀)
b_{y}=3(y₂−y₁)−c_{y}
a_{y}=y₃−y₀−c_{y}−b_{y}

Physically, the position of each control point determines the slope of the Bezier curve at the corresponding end point. For these examples, the half-width of the structure was fixed at 1 by setting x₀=0 and x₃=1 and selecting the second end point to be the 0 reference point in the orthogonal direction by setting y₃=0. The tangent at the peak of the structure's shape was fixed at zero by setting y₁=y₀. The remaining free parameters then were y₀ (the height of the structure), x₁ (sharpness of the peak of the structured), x₂ and y₂.

The table below shows the optimized parameters for the three indices:

TABLE 2

| N | y₀ | x₁ | x₂ | y₂ |
|---|---|---|---|---|
| Shape #1 n = 1.49 | 0.95 | 0.54 | 0.18 | 0.77 |
| Shape #2 n = 1.545 | 1.0 | 0.476 | 0.22 | 0.93 |
| Shape #3 n = 1.62 | 1.0 | 0.24 | 0.42 | 0.95 |
| Shape # 4 n = 1.65 | 1.21 | 0.38 | 0.40 | 0.76 |

The following ranges were selected: 0.75<y₀<1.25, 0.1<x₁<0.6, 0.1<x₂<0.6, 0.5<y₂<1.0. This covers flat spheres and slightly rounded prisms of different heights.

The sensitivity of each optimized shape to the index of refraction of the structure is shown in Table 3. For these modeled results, the light guide plate index of refraction was set to 1.49, the light source center-to-center spacing was 25 mm, and the distance from the light sources to the input surface of the light guide was 0.25 mm.

TABLE 3

| | Tape n = 1.49 | Tape n = 1.545 | Tape n = 1.62 | Tape n = 1.65 |
|---|---|---|---|---|
| Shape #1 n = 1.49 | Eff = 91.3% | Eff = 90.5% | Eff = 88.7% | |
| | Unif = 17.4% | Unif = 31.64% | Unif = 43.8% | |
| | Non-TIR = | Non-TIR = 40% | Non-TIR = | |
| | 36.5% | | 43.2% | |
| Shape #2 n = 1.545 | Eff = 91.3% | Eff = 90.4% | Eff = 88.6% | |
| | Unif = 13.0% | Unif = 33.5% | Unif = 49.1% | |
| | Non-TIR = | Non-TIR = | Non-TIR = | |
| | 36.3% | 39.9% | 43.4% | |
| Shape #3 n = 1.62 | Eff = 91.4% | Eff = 90.5% | Eff = 88.8% | |
| | Unif = 10.1% | Unif = 28.0% | Unif = 49.1% | |
| | Non-TIR = | Non-TIR = | Non-TIR = 47% | |
| | 38.9% | 42.8% | | |
| Shape #4 n = 1.65 | | | | Eff = 88.0% |
| | | | | Unif = 59.6% |
| | | | | Non-TIR = |
| | | | | 49.5% |

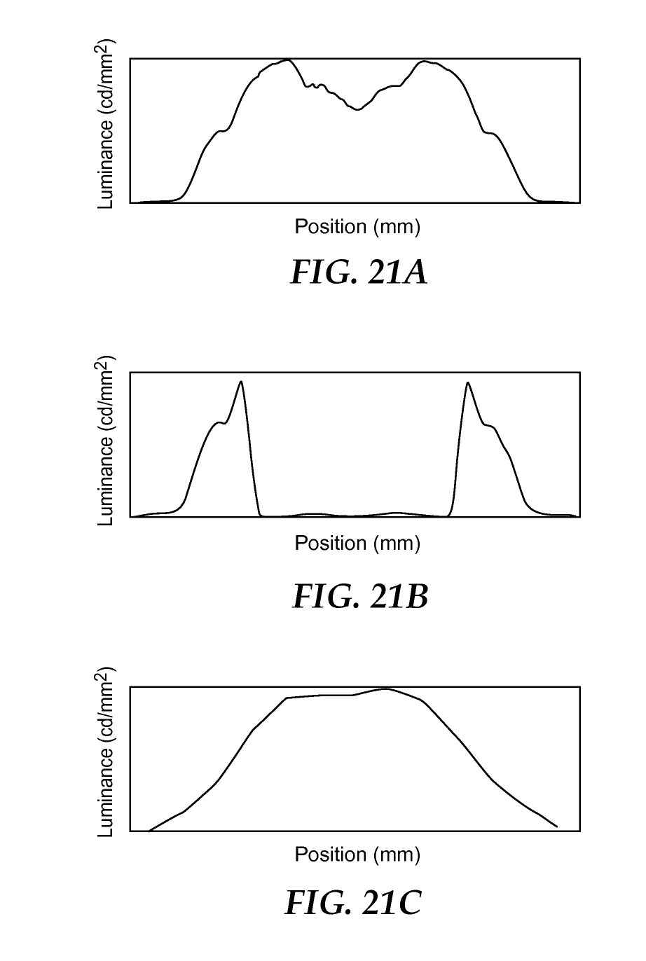

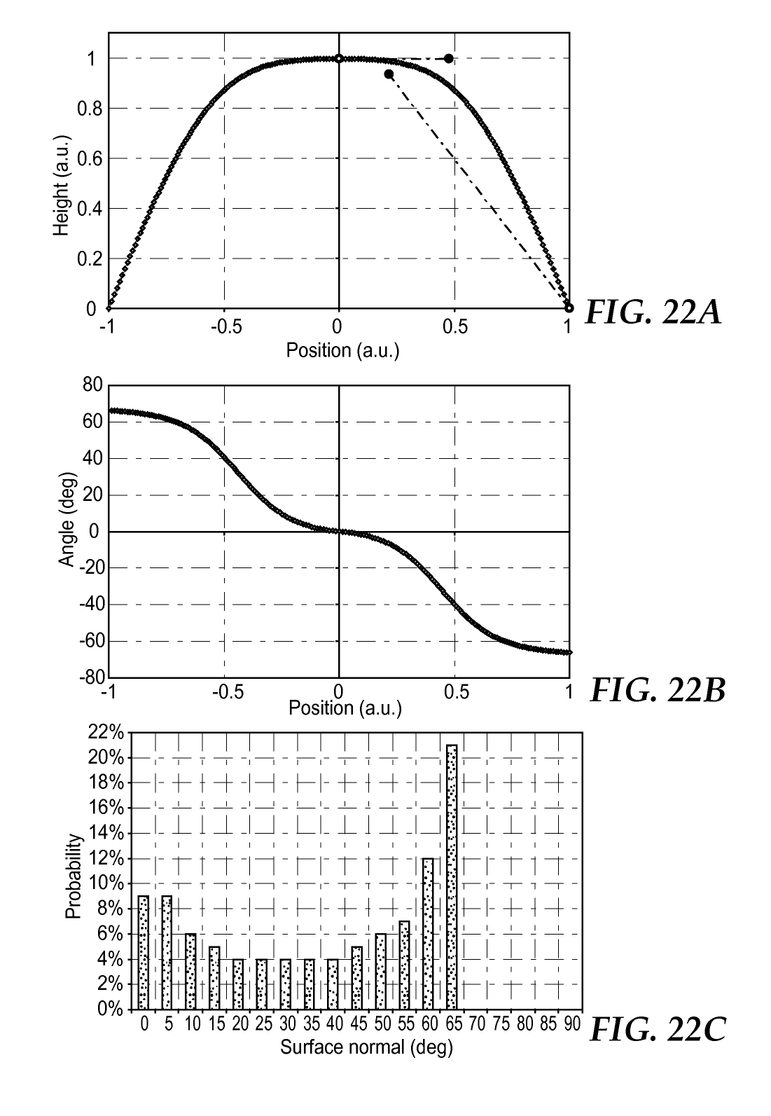

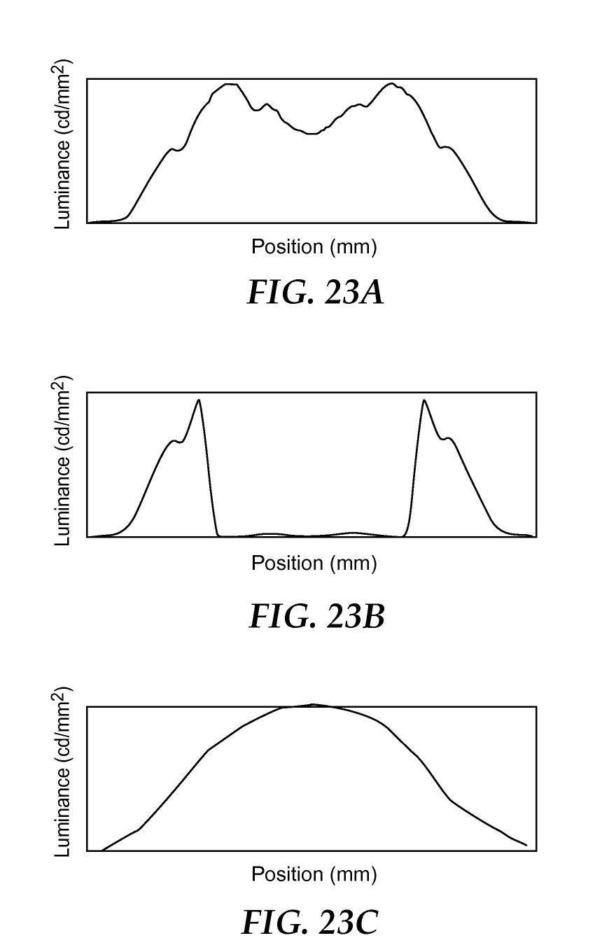

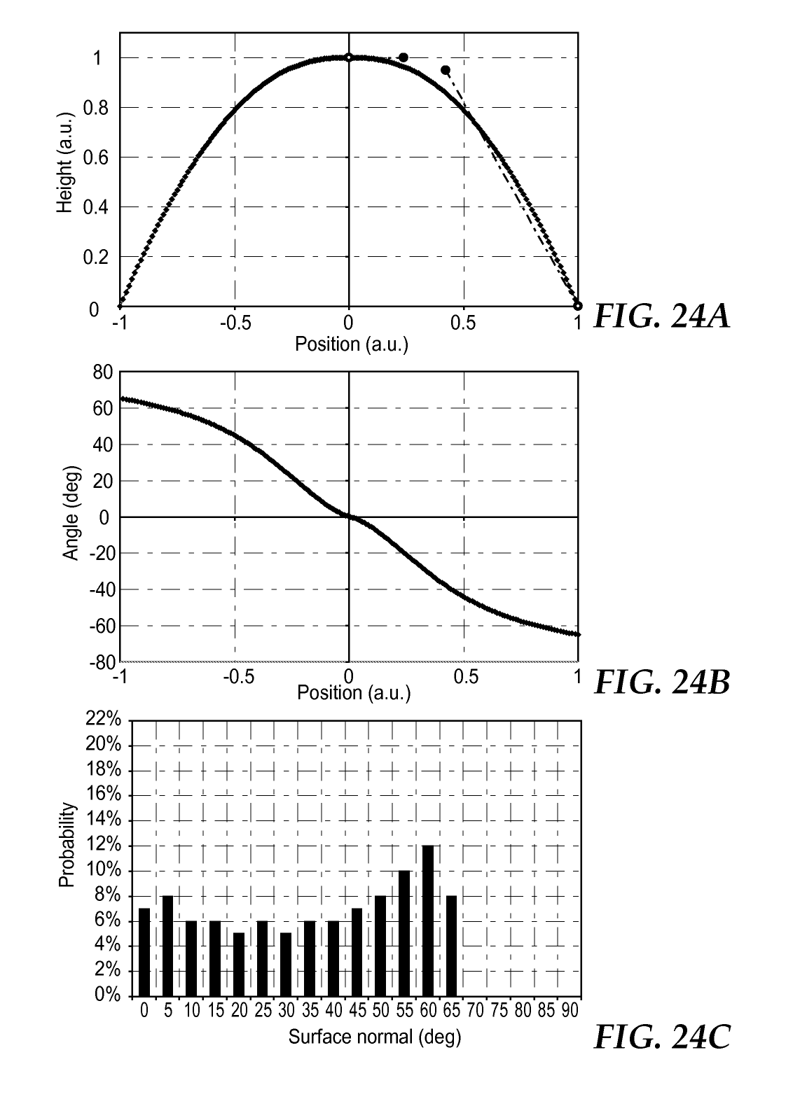

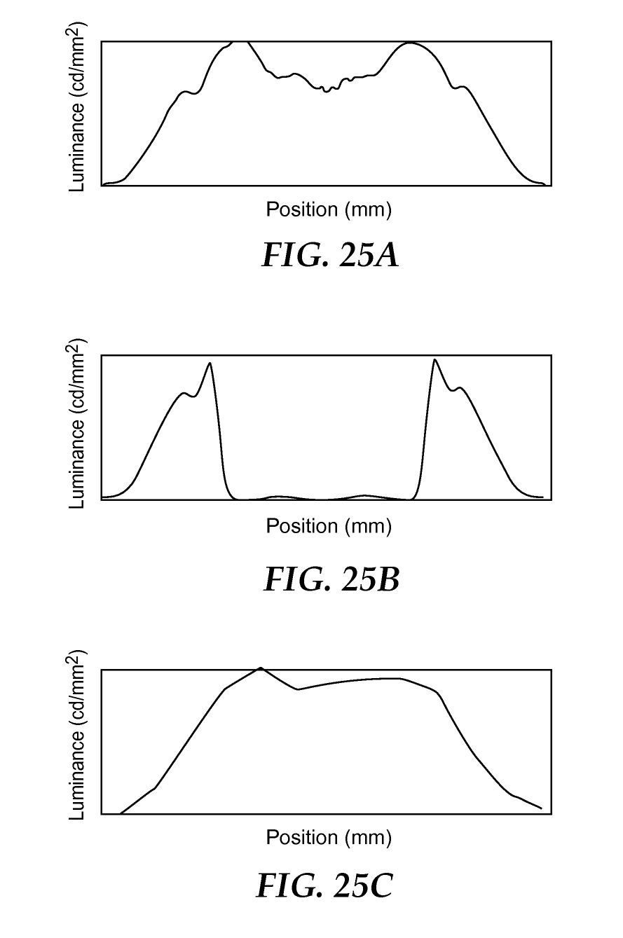

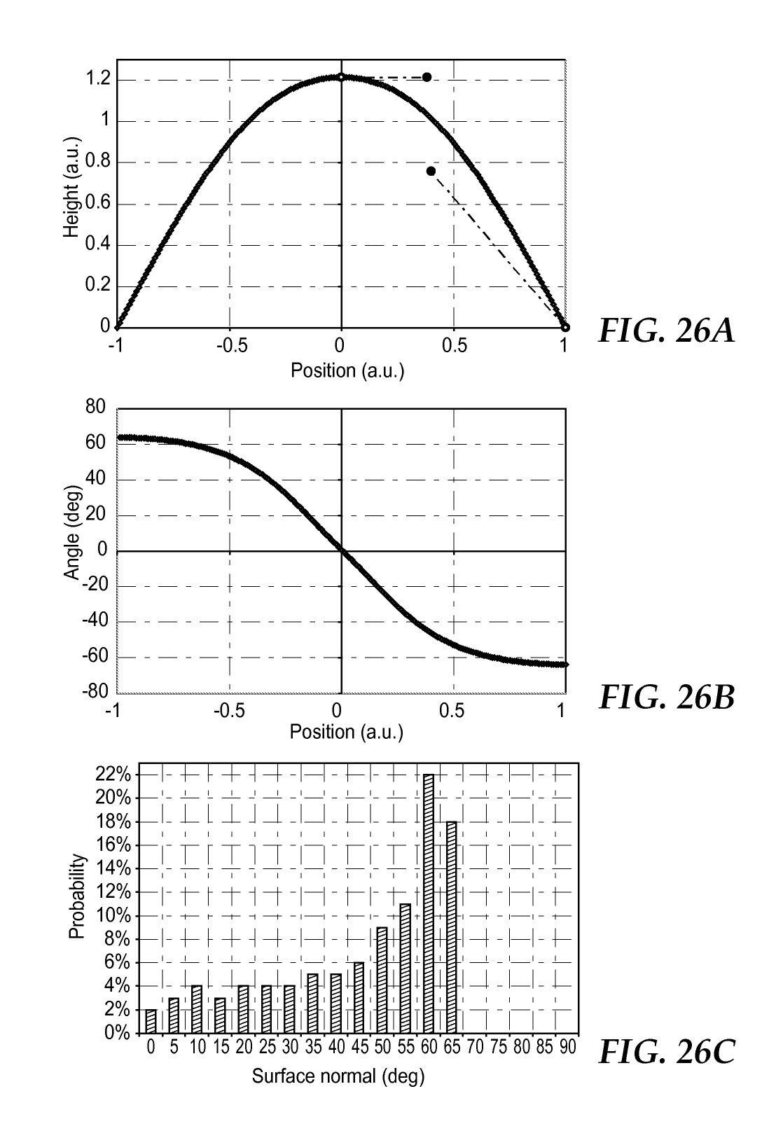

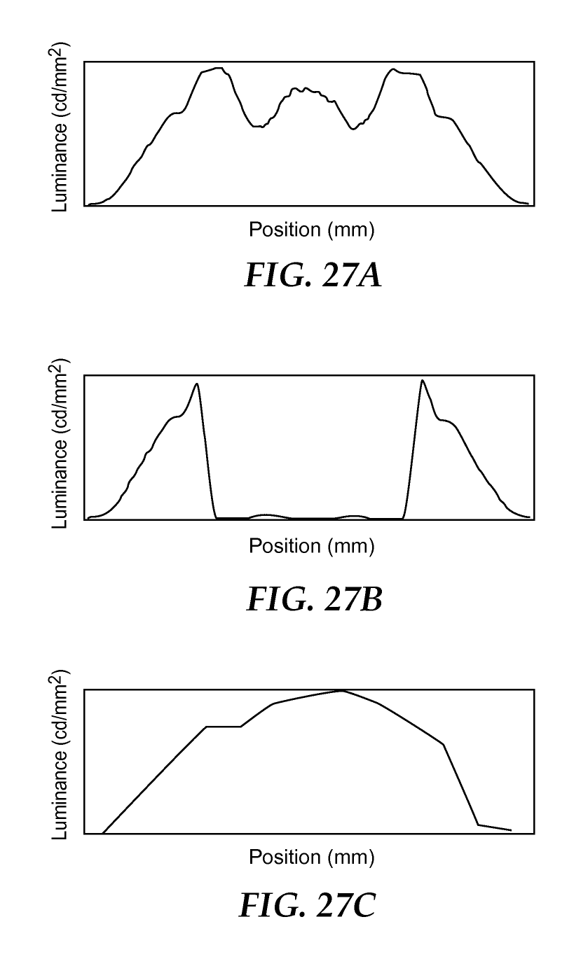

FIGS. 20A-C, 22A-C, 24A-C, and 26A-C are graphs of the Bezier Curve, surface normal distribution, and surface normal probability distribution for an optimized structure shape for structures having an index of refraction of 1.49, 1.545, 1.62 and 1.65, respectively. And FIGS. 21A-C, 23A-C, 25A-C, and 27A-C show luminance versus position for the structures shown in 20A-C, 22A-C, 24A-C, and 26A-C. FIGS. 20A, 22A, 24A, and 26A illustrate that, in some embodiments, the optimum angular distribution of the coupled light has a batwing distribution, and that acceptable uniformity can be achieved by balancing the light transmitted on-axis (i.e., orthogonal to the input surface of the light guide) with off-axis light.

For a given refractive index of the tape, the shape optimized for that particular refractive index delivers better system uniformity than alternative shapes. However, for a given shape, a higher refractive index of the tape provides better uniformity, no matter which index the shape was optimized for. The desired uniformity can be achieved by combining a structure shape that effectively couples a broad range of in-plane angles in the structured surface layer itself (well past the refraction limit for a flat interface) and a high index of refraction of the structures, which determines the amount of light spreading due to refraction into the guide from the structured surface layer.

The surface normal distribution is defined as the direction of the local surface normal of the structured surface (in degrees, measured relative to the surface normal of the input surface of the light-guide) as a function of position. The surface normal probability distribution then is defined as the probability of the surface normal direction at a random location on the structured surface to be within a certain angular range (here +/−5 deg) as a function of angle.

The shape of structures of the structured surface layer primarily controls the light distribution as a function of angle within the refracted cone in the light guide. The optimum shape must (1) ensure that not light is coupled to the guide passed the TIR angle in the thickness direction of the guide; and (2) balance the amount of light that is coupled to the guide within the TIR cone and outside the TIR cone in the plane of the guide to deliver good brightness uniformity near the edge of the guide. Too much light within the TIR cone results in dim spots between the LEDs (no tape case) while too much light outside the TIR cone results in dim spots at the LED location (BEF case). See, e.g., FIGS. 21A-C.

In some embodiments, for a detector 5-mm away from the light guide entrance, the fraction of shallow surfaces (surface normal <10 deg) that do not contribute to much angular spreading can be less than 50%, less than 30%, less than 10%, but no less than 5%. The fraction of steep surfaces (>70 deg) with high reflectivity and small duty cycle (very little first bounce interaction) can be small to maintain high coupling efficiency, i.e., less than 15%, preferably less than 5%. Finally, the fraction of surfaces that most contribute to spreading the light in the plane of the guide and deliver the preferred batwing angular distribution (i.e., 15 degrees to 65 degrees) should be no less than 40%.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An illumination assembly, comprising:
a light guide comprising an output surface and an input surface along at least one edge of the light guide that is substantially orthogonal to the output surface;
a plurality of light sources positioned to direct light into the light guide through the input surface; and
a structured surface layer positioned between the plurality of light sources and the input surface of the light guide, wherein the structured surface layer comprises a substrate and a plurality of structures on a first surface of the substrate facing the plurality of light sources, wherein the plurality of structures comprises a refractive index n₁ that is different from a refractive index n₂ of the light guide.

2. The assembly of claim 1, wherein |n₁−n₂| is greater than 0.01.

3. The assembly of claim 1, wherein n₁ is greater than n₂.

4. The assembly of claim 1, wherein the structured surface layer is attached to the input surface of the light guide with an adhesive layer.

5. The assembly of claim 4, wherein the adhesive layer comprises a pressure sensitive adhesive.

6. The assembly of claim 4, wherein the adhesive layer comprises a refractive index n₃ that is less than n₁.

7. The assembly of claim 1, wherein one or more structures of the plurality of structures of the structured surface layer extends along an axis that is substantially normal to the output surface of the light guide.

8. The assembly of claim 7, wherein the plurality of structures comprises prismatic structures.

9. The assembly of claim 7, wherein the plurality of structures comprises aspheric structures.

10. The assembly of claim 7, wherein the plurality of structures comprises lenticular structures.

11. The assembly of claim 1, wherein the plurality of structures comprises a first set of structures and a second set of structures different from the first set of structures.

12. The assembly of claim 1, wherein the light guide further comprises a plurality of extraction features operable to direct light from the light guide through the output surface of the light guide.

13. The assembly of claim 12, wherein the plurality of extraction features is disposed proximate a back surface of the light guide that is substantially parallel to the output surface.

14. The assembly of claim 1, wherein the light guide further comprises a back reflector disposed proximate a back surface of the light guide that is substantially parallel to the output surface.

15. The assembly of claim 1, further comprising one or more side reflectors disposed proximate one or more edges of the light guide, wherein the one or more edges are substantially orthogonal to the output surface.

16. The assembly of claim 15, wherein the one or more side reflectors are specularly reflective.

17. The assembly of claim 15, wherein the one or more side reflectors are semi-specularly reflective.

18. The assembly of claim 1, wherein the plurality of light sources are disposed along a y-axis that is substantially parallel to the input surface and the output surface, and wherein a distance from a primary emitting surface of at least one light source of the plurality of light sources is at least 15 mm from a primary emitting surface of an adjacent light source of the plurality of light sources.

19. The assembly of claim 1, wherein a distance from a primary emitting surface of at least one light source of the plurality of light sources to the input surface of the light guide is less than 5 mm.

20. The assembly of claim 19, wherein the light guide further comprises a plurality of extraction features operable to direct light from the light guide through the output surface, wherein one or more extraction features are positioned at a distance from the input surface of the light guide of less than 10 mm.

21. The assembly of claim 1, wherein a light distribution on a plane parallel to the input surface along a thickness direction z of the light guide and about 5 mm within the light guide from the input surface has a uniformity of (Lₘᵢₙ/Lₘₐₓ)×100% of greater than 50%.

22. The assembly of claim 1, wherein at least 80% of the light from the plurality of light sources is directed into the light guide through the input surface.

23. The assembly of claim 1, wherein the substrate of the structured surface layer comprises a refractive index n₄ that is less than n₁.

24. The assembly of claim 1, wherein the plurality of light sources and the structured surface layer are operable to direct at least a portion of light into the light guide through the input surface at an angle of at least 45 degrees to a normal to the input surface in the plane of the light guide.

25. The assembly of claim 1, wherein the structured surface layer further comprises non-structured portions of the first surface of the substrate.

26. The assembly of claim 1, wherein the structured surface layer comprises a plurality of segmented portions that are attached to the input surface of the light guide.

27. The assembly of claim 1, further comprising:
a plurality of light sources positioned to direct light into the light guide through a second input surface along a second input surface of the light guide that is substantially orthogonal to the output surface; and
a structured surface layer positioned between the plurality of light sources and the second input surface of the light guide, wherein the structured surface layer comprises a substrate and a plurality of structures on a first surface of the substrate facing the plurality of light sources, wherein the plurality of structures comprises a refractive index n₁ that is greater than a refractive index n₂ of the light guide.

28. The assembly of claim 1, further comprising a bezel disposed around a periphery of the assembly, wherein a primary emitting surface of at least one light source of the plurality of light sources is positioned within 15 mm of an edge of the bezel closest to the output surface of the light guide along a normal to the input surface.

29. The assembly of claim 28, wherein the uniformity of an output light flux distribution of the assembly measured at about 1 mm from the bezel into the output surface is greater than 40%.

30. A display system, comprising:
a display panel; and
an illumination assembly disposed to provide light to the display panel, the assembly comprising:
a light guide comprising an output surface and an input surface along an edge of the light guide that is substantially orthogonal to the output surface;
a plurality of light sources positioned to direct light into the light guide through the input surface;
a structured surface layer positioned between the plurality of light sources and the input surface of the light guide, wherein the structured surface layer comprises a substrate and a plurality of structures on a first surface of the substrate facing the plurality of light sources, wherein the plurality of structures comprises a refractive index n₁ that is greater than a refractive index n₂ of the light guide.

31. The system of claim 30, wherein the light guide further comprises a plurality of extraction features operable to direct light from the light guide through the output surface of the light guide.

32. A method of forming an illumination assembly, comprising:
forming a light guide comprising an output surface and an input surface along at least one edge of the light guide that is substantially orthogonal to the output surface;
positioning a plurality of light sources proximate the input surface such that the light sources are operable to direct light into the light guide through the input surface; and
attaching a structured surface layer to the input surface of the light guide such that the structured surface layer is between the plurality of light sources and the input surface, wherein the structured surface layer comprises a substrate and a plurality of structures on a first surface of the substrate facing the plurality of light sources, wherein the plurality of structures comprises a refractive index n₁ that is greater than a refractive index n₂ of the light guide.

33. The method of claim 32, further comprising:
selecting a desired output light flux distribution; and
forming a plurality of light extraction features on a back surface of the light guide that is substantially parallel to the output surface, wherein the light extraction features are designed to direct the light from the light guide through the output surface to provide the desired output light flux distribution.
